(19) United States
(12) Patent Application Publication
(10) Pub. No.: US 2015/0294065 A1
(43) Pub. Date: Oct. 15, 2015

(54) Database-Driven Primary Analysis of Raw Sequencing Data

(71) Applicant: TECHNICAL UNIVERSITY OF DENMARK, Lyngby (DK)

(72) Inventors: Laurent Gautier, Arlington, MA (US); Ole Lund, Copenhagen (DK)

(21) Appl. No.: 14/435,323

(22) PCT Filed: Oct. 11, 2013
(86) PCT No.: PCT/EP2013/071280

§ 371 Date: Apr. 13, 2015

(30) Foreign Application Priority Data
Oct. 15, 2012 (EP) 12188538.8

(51) Int. Cl. G06F 19/22; G06F 19/28

(52) U.S. Cl. CPC G06F 19/22; G06F 19/28

(57) ABSTRACT

The present invention relates to methods for identifying the source of a biological sequence containing sample from raw sequencing reads. The method may be used to identify the source of unknown DNA and can be used for diagnostic, biodefense, food safety and quality, and hygiene applications. In another aspect the invention relates to a database of reference sequences which can be used in the method of the invention.

### FIELD OF INVENTION

The present invention relates to methods for identifying the likely source of biological sequences. In further aspects the invention relates to a database adapted to be used for this purpose.

### BACKGROUND OF INVENTION

DNA sequencing is an experimental process during which the sequence of bases (A, T, C, or G) are identified. As of today, no technology is capable of sequencing a full molecule of DNA beyond a few thousands of bases with most of the technologies sequencing between 100 and 200 bases. A bacterial genome can easily contain a few millions of bases. Over the last years, sequencing costs have been significantly reduced thus making large scale sequencing of DNA from samples for purposes such as human health, quality control in food, or the study of microbial communities increasingly common. It is conceivable that sequencing of full human genomes will be used more frequently in therapy in order to personalise the treatment to the extent possible, and that routine sequencing will be performed to control the presence or absence of specific living organisms. Identifying quickly the likely origin DNA, either as an end goal in itself or as stepping stone to more complex data analysis or a quality control step for sequencing data before more costly analysis is undertaken, is quickly becoming a necessity.

The primary analysis consists of making sense of the relatively short sequences (called short reads) obtained from sequencing by either aligning them to a reference genome (which requires that the sequence for the reference species is known) or by trying to reconstitute the jigsaw without a model (so-called de-novo assembly of the sequencing tags—indentifying the content of an unknown sample will require a supplementary step). Aligning against a reference is believed to be a computationally much easier task than de novo assembly.

Before unspecific or whole-genome sequencing was affordable, specific regions were first painstakingly sequenced and assembled, putative regions of interest were identified. The simplest method being the search for open reading frames (ORF) by finding intervals defined by the start codon for the translation of RNA into proteins (ATG/AUG) and one of stop codons terminating the translation (TAG/UAG, TAA/UAA, TGA/UGA). The ORF where then aligned against lists of all known genes. Methods for alignment include alignment algorithms and programs such as the Smith and Waterman algorithm, the BLAST algorithm and program, SSAHA, and BLAT. Their aim is to find the optimal alignment in a database of indexed sequences and through ranking of scores to all alignments find the best matches and thereby the most likely function for the query sequence. An increasing number of similar matches with different biological functions, lead to an expansion of that principle by building “groups of best-matching genes”, or clusters of orthologous genes (COGs), for the purpose of functional annotation. As complete genomes were slowly becoming more available, the Mummer algorithm was designed to align pairs of complete genomes and visualize how overall genomic structures were comparing between genetically related species.

Because of the number of sequences currently available in databases, aligning a new sequence against a huge pool of known sequences may take a relatively long time, and BLAST was a breakthrough in the sense that it speeded up the previous algorithm while finding almost optimal results. However, in an age where web-based search engines can return search results almost instantaneously searching against all known sequences remains relatively slow.

Ning et al 2001, (Genome: 11:1725-1729), describe an algorithm, SSAHA (sequence search and alignment by hashing algorithm), for performing fast alignment on databases containing multiple gigabases of DNA. SSAHA is an aligner; therefore with the task of reporting for each full query sequence where and how well it is matching each entry in a collection of reference sequences. The SSAHA method is for finding as many matches as possible over the full length of the query sequence. Sequences in the database are pre-processed by breaking them into consecutive k-tuples of k contiguous bases and then using a hash table to store the position of each occurrence of each k-tuple. Searching for a query sequence in the database is done by obtaining from the hash table the “hits” for each k-tuple in the query sequence and then performing a sort on the results. The SSAHA algorithm is used for high-throughput single nucleotide polymorphism detection and very large scale sequence assembly. In SSAHA, presence and position of each k-tuple is stored in the same lookup structure, and that structure is loaded in to memory of the computer system.

Known mapping or alignment algorithms and programs include methods such as Erland, Corona, BFAST, Bowtie, BWA, NovoAlign. Their aim is to find the position of reads in known references. By extension, reads for which no match can be found can be flagged as not coming from the sequence. These programs and algorithms also suffer from the drawback of long search times, because they both assess every sequence in the query set, that is every sequencing read, and because they try to find the optimal alignment, often called alignment when working with short reads, for all of them. Interestingly, the programs above differ in the results they find as they all use heuristics in order to trade exactitude for speed.

US 2006286566 discloses methods of using k-mers to detect mutations. The method involves detecting apparent mutation in target nucleic acid sequences by comparing a portion of target nucleic acid sequence with second sequence segments to detect a match for portion of target nucleic acid sequence.

US2012000411 discloses systems and methods capable of characterizing populations of organisms within a sample, which are based on matching of short strings of sequence information to identify genomes from a reference genomic database. The patent application does not disclose a method wherein the presence of a short string is searched in one collection of short strings in reference sequences and the position is searched in another collection of positions in reference sequences.

### SUMMARY OF INVENTION

The present invention provides a novel method for identifying the source of raw sequences such as DNA reads (or short reads) obtained from a sequencing machine or protein sequences obtained from N- or C-terminal sequencing or from mass spectrometry. The method relies on a collection of reference sequences indexed beforehand and a system to score incoming query sets of biological sequences, such as reads from a sequencing machine, and on a system to submit parts of the query set. This may be done by using a client-server based approach, with the server entity holding the collection of references and performing the scoring while the client submits the subset of query sequences.

The approach provided by the present invention, allows for the rapid determination of different sources of DNA found in a sample, and does not rely on knowledge of the complete sequences of a given gene of the source sequence nor of the reference sequence.

Short reads, albeit not representing the complete reference they originate from, hold a signature signal for the reference. The short reads can be further broken down into sub-sequences (called k-mers or k-tuples) and those k-mers searched in a collection of indexed k-mers in order to identify the source of the raw sequencing data.

In a first aspect the invention relates to a method of identifying the likely source of biological sequences, the method comprising:
a) Sampling a subset of sequences or short reads from a source,
b) Fragmenting sequences from the subset into k-mers,
c) Querying k-mers from said subset against a database comprising k-mers of reference sequences,
d) Determining which reference(s) contain(s) the k-mers, and
e) Returning a description of likely source references.

The method carries several advantages over traditional alignment and mapping algorithms which focus on aligning the full query set therefore require the transmission of the whole sequence from an input device (such as a client) to a database and scoring unit (such as server) which can perform the alignment. According to the present invention only a subset of the sequences are subjected to fragmentation and querying thus minimising the need for data transmission. The subset transmitted can be for example, but not limited to, a random subset of fixed size, a filtered subset, an adaptive sampling, a iterative synchronous or asynchronous dialogue between the input and the scoring entity, or any combination of thereof.

Compared to methods based on the assembly of sequencing reads, or genome building, followed by a search or to method mapping all reads over a collection of references, the present methods require considerably less computer processing power by not trying to perform a full alignment and by working on a subset of data, and a results can thus be obtained within seconds. Thus, the methods of the present invention can be run using a client-server approach, for example with tablet or hand-held devices having less computer processing power (such as for example mobile phones) as clients. Since a result can be obtained relatively fast for one subset of data, the time required for searching additional subsets of data is considerably reduced. This way, the identity of different sources of DNA in a sample may be determined in a considerably reduced time-period compared to conventional methods based on alignment of whole sequences.

In its broadest aspect the invention relates to querying only for presence in the database. However, in a preferred embodiment, the database is also queried for position of the k-mer in the reference sequence, thus allowing computation of the consecutiveness of the source k-mers and making the assessment more precise. Organisms often being genetically related to one another, the invention is also able to find close parents in a collection of reference sequences.

Compiling the data in two separate databases or collections allows decoupling the search for presence of k-mers in a reference from the search for positions and considering optimizations such as caching as much of the search for presence as possible into memory, where it may be faster to search than in persistent storage. Search for position may be made if a k-mer is found present, and in a supplementary optimization step if present enough times in a given reference. Thus a preferred embodiment of the invention relates to a method of identifying the likely source of biological sequences, the method comprising:
a) Sampling a subset of sequences from a source,
b) Fragmenting sequences from the subset into k-mers,
c) Querying k-mers from said subset against a first collection comprising k-mers of reference sequences,
d) Querying k-mers from said subset against a second collection comprising positions of k-mers in reference sequences,
e) Determining which reference(s) contain(s) the k-mers, and
f) Returning a description of likely source references,
   wherein the collection comprising k-mers of reference sequences is separate from the collection comprising the positions of k-mers in reference sequences.

Thus a preferred embodiment of the invention relates to a method of identifying the likely source of biological sequences, the method comprising:
a) Sampling a subset of sequences or short reads from a source,
b) Fragmenting sequences from the subset into k-mers,
c) Querying k-mers from said subset against a first collection comprising k-mers of reference sequences,
d) Querying k-mers from said subset against a second collection comprising positions of k-mers in reference sequences,
e) Determining which reference(s) contain(s) the k-mers, and
f) Returning a description of likely source references,
   wherein the collection comprising k-mers of reference sequences is separate from the collection comprising the positions of k-mers in reference sequences.

One notable feature of the present invention is that information about a likely reference is returned to the user once a likely reference has been identified. The returned information may e.g. be information about the likely species, and its origin or source and/or the full genomic sequence of the likely species. This allows the user to align the remaining raw reads from the unknown sample to the reference sequence using state of the art alignment or genome building algorithms in order to identify small variations such as mutations, and inserts.

In a further aspect the invention relates to a database comprising k-mers of reference sequences, said database comprising:
a) A first collection of k-mers from reference sequences, and
b) A second collection of position of each k-mer in the reference sequences.

Compiling the data in two separate databases or collections allows decoupling the search for presence of k-mers in a reference from the search for positions and considering optimizations such as caching as much of the search for presence as possible into memory, where it may be faster to search than in persistent storage. Search for position may be made if a k-mer is found present, and in a supplementary optimization step if present enough times in a given reference.

In a third aspect the invention relates to a data processing system for identifying the likely source of a source sequences, the system preferably comprising an input device, a central processing unit, a memory, and an output device, wherein said data processing system has stored therein data representing sequences of instructions which when executed cause the method of the invention to be performed, the memory further comprising a database according to the invention.

FIG. 3 illustrates key points of one embodiment of the system of the invention. Key points are that sampling is performed on the “client”, resulting in a minimal amount of information is transmitted. Use for the descriptors of most-likely reference is not illustrated in the figure.

The devices (input, output, memory, CPU) may be handheld, stationary, cloud and/or online based.

Preferably the database is stored in a server, and the input and output devices are one or multiple clients, the clients and server being connected via data communication connection and the sharing of the server allowing a centralization of the collection of references and a distribution of the computing power in the server across clients if running on separate processes or even separate machines. In such embodiments, the client may comprise a sequence of instructions enabling the client to sample a sub-set of source sequences, fragment these into k-mers, and transmit these to the server.

The client may further comprise a sequence of instructions allowing it to dialog with the server to adapt or interrupt the sampling procedure or, perform assembly of source sequences into one or more larger sequences based on sequences transmitted to the client from the server.

In one implementation the system is connected via a data connection to a sequencing apparatus.

In further aspects, the invention relates to a computer software product containing sequences of instructions which when executed cause the method of the invention to be performed, and to an integrated circuit product containing sequences of instructions which when executed cause the method of the invention to be performed.

### DESCRIPTION OF DRAWINGS

FIG. 1. Building of the “presence” and “position” databases.

FIG. 2. Scoring a set of query DNA fragments, typically raw reads from sequencing.

FIG. 3. General description of the architecture of the system of the invention.

FIG. 4: Average rank (x-axis) and standard deviation of the ranks (y-axis) for 747 bacterial genomes in the database used as a query, according to varying reads size (rows) and random substitution rates (columns).

FIG. 5: An overview of a specific example of indexing and scoring procedures, which is also used in Examples 1 and 2. (A) During the indexing of a collection of reference sequences, non-overlapping k-mers are indexed into two distinct key-value stores, one associating k-mers with the references they were found in (‘presence’) and one associating k-mers with the position in the reference at which the k-mer was found (‘position’). (B) When processing a sequencing read in a query set, overlapping k-mers looked up in the ‘presence’ store. Using overlapping k-mers allows to resolve misalignments relatively rapidly between the beginning of the read and the beginning of the reference sequence (dotted lines). On the figure, only a subset of the k-mers are in phase with the indexing step, therefore only those can be found in ‘presence’. (C) For a given read, a threshold is applied to only retain references potentially matching enough of the read. Situations where very large references containing disjoint scattered k-mers, such as a bacterial read against a mammalian genome, are resolved in the last step where the ‘position’ store is queried, using for example the highest concentration of k-mers within the smallest region in the reference.

FIG. 6: Bacterial reads. For each bacterial genome in a set of 747 genomes, we simulated several read lengths (50 nucleotides (nt), 75 nt, 100 nt, 150 nt, 200 nt, 250 nt) and several substitution error rates (0%, 1%, 5%, 10%). 100 random reads were used in each query and the distribution of the rank of the correct references in the list recorded; a rank of 1 means that the correct reference was at the very top of the list. The list of hits returned was set to a maximum length of 25 and we counted the reference as ‘not found’ if not in the list at all. The percentages of correct test bacterial genomes are represented in a bar nested on right side of each panel. The figure shows that, as expected, the performances degrade as the error rate increases, but also shows that reads of length 50 appear to have relatively decreased performance. Increasing the read length beyond 100 nucleotides brings only small improvements compared to reads of 100 nucleotides, and has a limited compensatory effect on the error rate.

FIG. 7: Bacterial reads (number of reads). For each bacterial genome in a set of 747 genomes, we simulated several read lengths (50 nt, 75 nt, 100 nt, 150 nt, 200 nt, 250 nt) and several substitution error rates (0%, 1%, 5%, 10%). 100, 200, or 300 random reads were used in each query and the distribution of the rank of the correct references in the list recorded; a rank of 1 means that the correct reference was at the very top of the list. The curves denote 100, 200 and 300 reads. It can be seen that increasing the number of reads in the random sample from 100 reads to 300 reads brings a relatively small increase in the performance. The error rate or the read length had a much stronger effect.

FIG. 8: Bacterial reads, variability of performances Average rank (rank, x-axis) and standard deviation of the rank (Srank, y-axis) of the true reference when performing 5 times one iteration of the identification procedure for 747 test bacterial genomes. The closest the average rank is to 1 the closest to a perfect performance, and the smallest the standard deviation of the ranks the least sensible to sampling effects. In order to increase clarity when a lot of the bacterial genomes tested produce equal or close coordinates on the scatter, we use hexagonal binning and color the areas accordingly. The vertical bar on the right side of each scatter plot indicates the number of test genomes that were not within the top 25 matches, and is coloured with the same scale as the hexagonal binning. Different reads size (rows) and error rates (random substitution, columns) were tried, producing a matrix of scatter plots.

FIG. 9: Bacterial reads, same species. Percentage of matches giving the correct specie, that is a reference in our collection that belongs to a bacterium of the same specie rather the correct exact same reference as shown FIG. 7, and the percentage of cases for which the correct specie was not in the top 25 matches. The performance is relatively low for the shorter reads (50 nt), with noise decreasing it further (barplot on the first row), but become extremely good from 100 nt and stays robust against noise.

### DETAILED DESCRIPTION OF THE INVENTION

The present invention balances speed and precision in performing identification of the likely source of biological sequences information from protein, DNA, or RNA found in a sample.

The sequence information to be used in the methods of the invention can e.g. be raw reads from a nucleic acid sequencing machine or from C- or N-terminal sequencing of proteins or from mass spectrometry protein sequencing. Thus, the word sample sequence in the context of the present invention refers to such raw reads also called short reads.

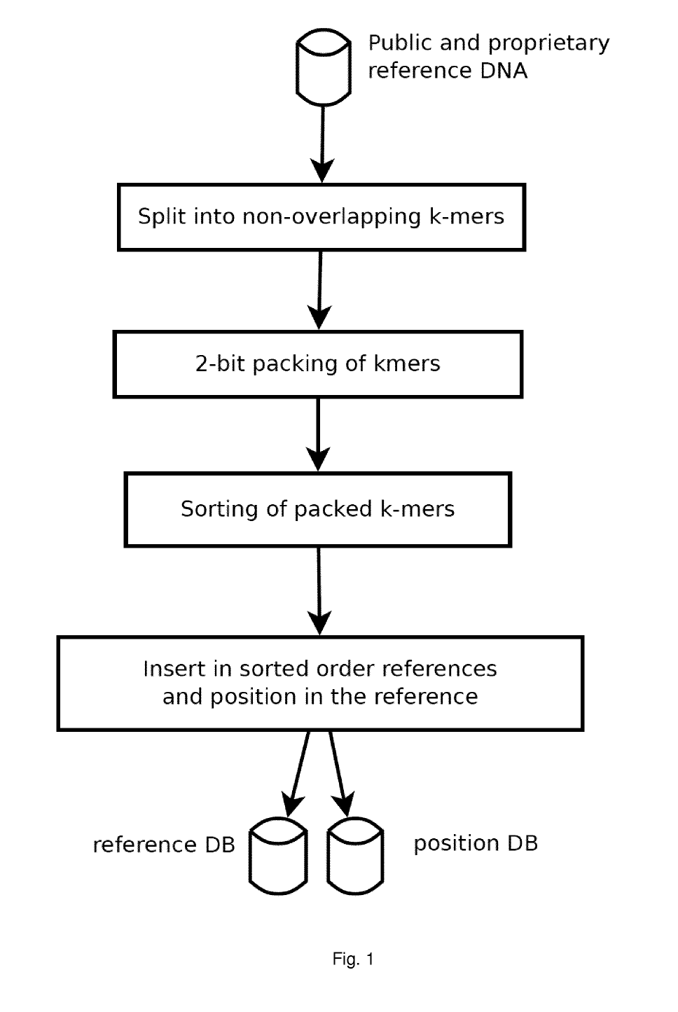

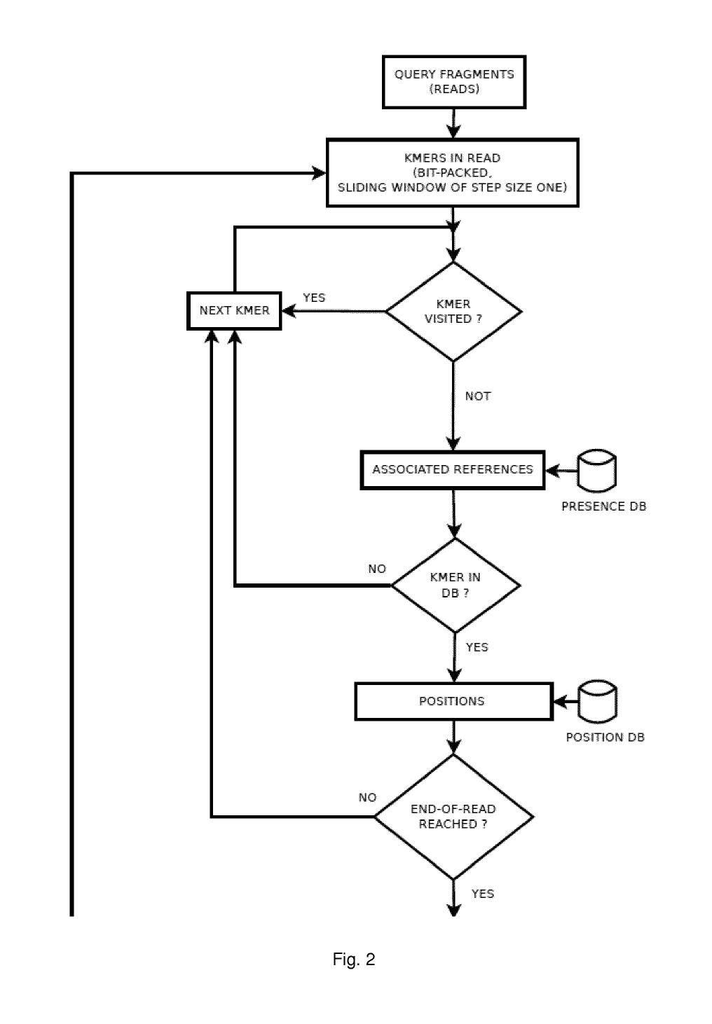

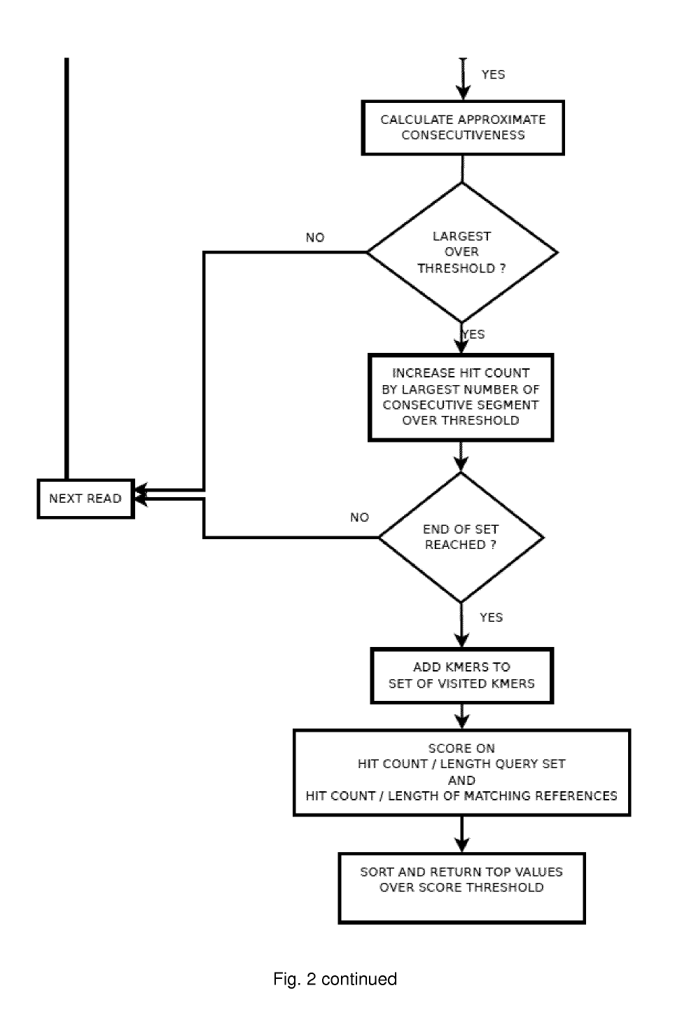

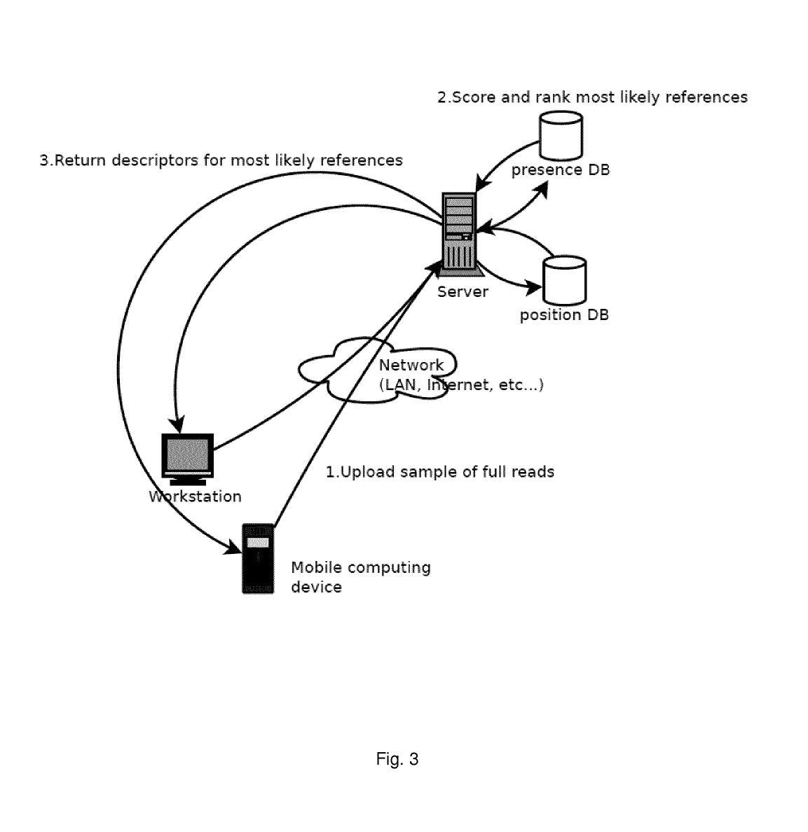

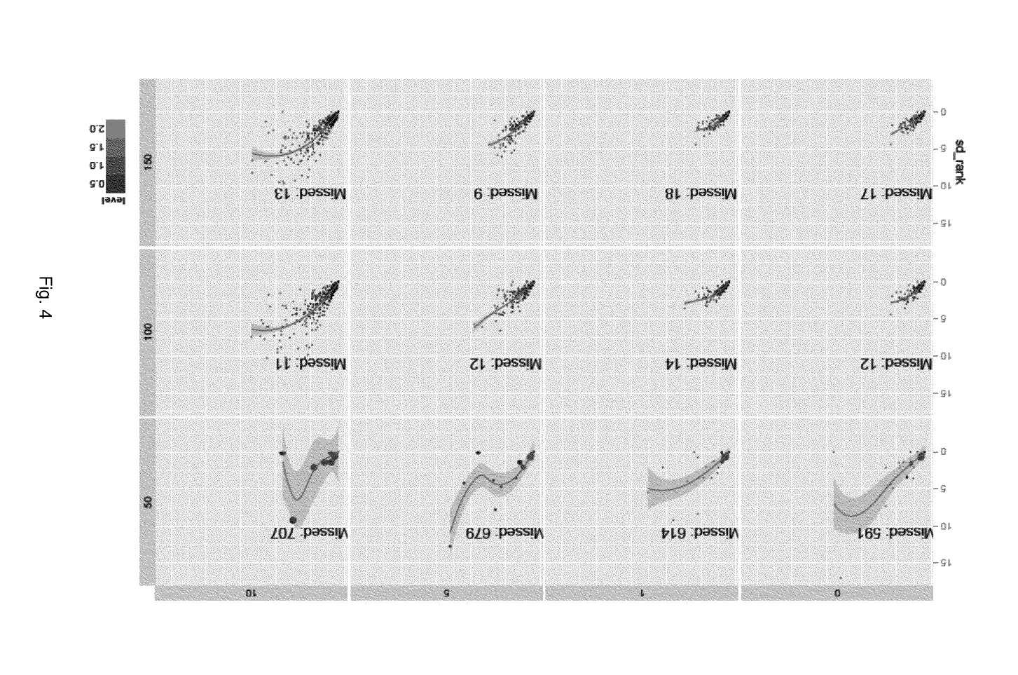

In one particular embodiment the invention described in FIG. 2 may involve:
Creating a database with reference DNA (see FIG. 1). The database is in two parts 1) a database of k-mers of all reference DNA indexed with respect to reference and 2) a database of association between k-mers from database 1 and position in the reference sequence. Thus reference k-mer ID and position is stored in two different databases.

FIG. 1 illustrates one embodiment of construction of the database. The input to create the database is DNA from public or proprietary databases. These are then split into K-mers, which may preferably be non-overlapping to save space. The k-mers may further be 2-bit bit packed, meaning that each base only takes up 2 bits of memory. In order to speed up storing the k-mers these are preferably sorted before insertion in the database. Furthermore the name of and position in the reference sequence from which the k-mer is derived may be stored in separate databases.
Searching a selection of reads broken down to k-mers of a query sequence from a source against the reference database.
The main score is computed from the number of k-mers from the query sequence that can be found in a given reference sequence in the database.
The suggested sequence(s) are returned to the user and may be used for more heavy and traditional analysis.

Characteristics of this implementation of the invention is:
During the search only exact matches of k-mers are registered.
A query read is broken into a number of k-mers for example of length 16. Starting point of each k-mer is incremented by 1.
Not “traditional” de novo, alignment or mapping method.

FIG. 2 illustrates one possible algorithm for searching the k-mer database. The reads are split into k-mers using a sliding window with a step size of one. If the k-mer has already been encountered (visited) in the current search, the next k-mer is selected. The k-mer is then looked up in the k-mer database. If it is in the database the identity of and position in the reference sequence is then retrieved. The approximate consecutiveness of the reads is then calculated and if the largest consecutive segment is over the threshold the hit count is increased. This is repeated for all k-mers in a read. For each read, scores are calculated as the number of hits (hit count) divided by the length of the query sequences, and the hit count divided by the length of the matching reference sequence is calculated. This is repeated for a number of reads, which can be defined a priori or dynamically depending on the scores obtained. The scores are the sorted and the best matches are returned to the user.

Exact matches are not made at the level of the read. The scoring allows missing k-mer matches along the read (so robustness against sequencing errors and mutations in the biological samples is ensured).

An overview of the system is:
Index all known reference DNA sequences into k-mers, storing the reference (e.g. species) and position in the reference sequence. This step is preferably only performed when reference DNA sequences are updated by addition of new sequences or by adding further sequence information.
A client that can store short sequences of DNA by splitting them into k-mers matching them against the database and counting the number of hits for reference sequences, preferably refining the matching with position information.

The reference obtained can subsequently be used to:
Filter out the reads matching the reference and find if DNA from another different reference but in lower abundance is present
Perform an alignment against that references, or iteratively building larger fragments using references in the database, this leading to much better performance than de-novo assembly by leveraging previously assembled references; moreover, the performances will increase as the size of the database increases and more assembled references are added
Identify the likely presence of various organisms or genes (relevant for example for diagnostic purposes).

As only a sub-sample of the raw reads is necessary this can decrease the amount of data to be transferred in order to perform rudimentary diagnostic such as identifying an infectious agent. In the case of smaller sequence experiments, this also allows some of the analysis to be carried out by a client on commodity hardware.

With development of low-throughput desktop sequencer (or disposable sequencing units) and the rise of cheaper GPU or FPGA unites the technique allowing real-time or close to real-time primary analysis of sequencing data.

The Algorithm

In one aspect the invention relates to a method of identifying the likely source of biological sequences, the method comprising:
a) Sampling a subset of sequences or short reads from a source,
b) Fragmenting sequences from the subset into k-mers,
c) Querying k-mers from said subset against a database comprising k-mers of reference sequences,
d) Determining which reference(s) contain(s) the k-mers, and
e) Returning a description of likely source references.

The term “sequences from a source” is used to designate sequences obtained from a sample comprising biological sequences. A sample may be an environmental sample, a sample from a subject such as a patient, a sample from a crime scene, a food sample, a water sample or the like. Samples are subjected to state of the art DNA/RNA or protein isolation and sequencing methods. The result is a set of sequences (also called reads) which are characteristic of that sample. The sequences are typically of random length within a certain interval. The sequences also typically are randomly overlapping. Each of the sequences from a sample, called source sequences, may be subjected to the method of the invention.

The term “reference” according to the present invention includes descriptors of sequences stored in the database. A typically example of a reference is a full genomic sequence of a particular species, or cultivar, or isolate. A reference may also consist of the transcriptome or proteome a particular species or a particular condition of a species. The transcriptome and proteome of a species may change over time in response to age and environmental conditions, while e.g. the genomic sequence of a species remains more or less constant over time. The database may store additional information about a reference.

The method of the invention can be applied to any biological sequence information such as amino acid sequences and nucleotide sequences, such as DNA and RNA sequences. In a preferred embodiment the sequences are DNA sequences.

In the broadest aspect the invention only relies on identification of the presence of k-mers from the query or source sequence. In that case the output from the algorithm is a list of references and the corresponding number of hits identified in the references. However due to the magnitude of some genomes such as the human genome and notably some plant genomes many k-mers may by chance be present in these very large genomes. Therefore in a preferred embodiment, the querying further comprises determining the position of the k-mers in the reference sequence. This allows presence and position to be used to determine consecutiveness of query k-mers in reference sequences. This makes the querying more precise as scores based on both presence and locality, or approximate consecutiveness of k-mers in references can be used.

Thus a preferred embodiment of the invention relates to a method of identifying the likely source of biological sequences, the method comprising:
a) Sampling a subset of sequences or short reads from a source,
b) Fragmenting sequences from the subset into k-mers,
c) Querying one or more k-mers from said subset against a first collection comprising k-mers of reference sequences,
d) Querying one or more k-mers from said subset against a second collection comprising positions of k-mers in reference sequences,
e) Determining which reference(s) contain(s) the k-mers, and
f) Returning a description of likely source references,
   wherein the collection comprising k-mers of reference sequences is separate from the collection comprising the positions of k-mers in reference sequences.

In an even more preferred embodiment of the present invention, the querying against a second collection comprising positions of k-mers in reference sequences is only done if a given k-mer has been found (i.e. is present) in the first collection comprising k-mers of reference sequences (see FIG. 2).

In a preferred embodiment of the present invention, when the above steps a) through f) are used, the presence and position for a given k-mer is determined prior to the querying a subsequent k-mer. Thus a preferred embodiment of the invention relates to a method of identifying the likely source of biological sequences, the method comprising:
a) Sampling a subset of sequences or short reads from a source,
b) Fragmenting sequences from the subset into k-mers,
c) Querying a k-mer from said subset against a first collection comprising k-mers of reference sequences,
d) Querying said k-mer from said subset against a second collection comprising positions of k-mers in reference sequences,
e) Determining which reference(s) contain(s) the k-mers, and
f) Returning a description of likely source references,
wherein the collection comprising k-mers of reference sequences is separate from the collection comprising the positions of k-mers in reference sequences.

One notable feature of the invention is that only a subset of the sequences obtained from sequencing is used for querying the database. This minimises the transfer of data, which may be a rate-limiting step when very large genomes are sequenced and queried. Thus the subset of sequences may comprise at least 1% of the discrete sequences, such as at least 2%, for example at least 4%, such as at least 5%, for example at least 6%, such as at least 7.5%, such as at least 10%, for example at least 15%. such as at least 25%, for example at least 30%, such as at least 35%, for example at least 40%, such as at least 50%.

One characteristic of the invention is that k-mer querying involves determining exact matches between query and reference k-mers.

When source sequences or short reads are queried, preferably querying involves querying all k-mers from at least one source sequence. This allows the best computation of consecutiveness or approximate consecutiveness. Preferably all k-mers from at least 50 source sequences are queried, such as from at least 100, for example from at least 150, such as from at least 200, for example from at least 250, such as from at least 300, for example from at least 400, such as from at least 500, for example from at least 750, such as from at least 1000, such as from at least 1500, for example from at least 2000, such as from at least 2500, for example from at least 5000 or more sequences. The exact number of source sequences queried is determined inter alia by network and computing capacity, time constraints, statistical requirements and the size of the full source sequences and the source's relatedness to different references.

As demonstrated in the examples, each source sequence is preferably of a given minimum length to give a characteristic fingerprint of the source organism, variety, cultivar, or isolate. In the case of source sequences being nucleotide sequences the source sequences preferably are of at least 50 nucleotide bases, more preferably at least 75 nucleotide bases such as 75 to 200 nucleotide bases for example such as 75 nucleotide bases to 100 nucleotide bases, or 100 nucleotide bases to 125 nucleotide bases, or 125 nucleotide bases to 150 nucleotide bases, or 150 nucleotide bases to 175 nucleotide bases, or 175 nucleotide bases to 200 nucleotide bases, even more preferably at least 100 nucleotide bases, such as 100 to 300 nucleotide bases for example such as 100 nucleotide bases to 150 nucleotide bases, or 150 nucleotide bases to 200 nucleotide bases, or 200 nucleotide bases to 250 nucleotide bases, or 250 nucleotide bases to 300 nucleotide bases, for example at least 100 nucleotide bases, such as 100 nucleotide bases, such as 200 nucleotide bases, for example at least 250 nucleotide bases, such as 300 nucleotide bases, for example 400 nucleotide bases, at least 500 or more nucleotide bases.

In many practical implementations one subset of sequences is initially queried. If this is not enough to determine the reference with high enough certainty, the method may further comprise selecting one or more further subsets of sequences and subjecting those to steps a) through e) or a) through f) of the method of the invention.

In principle the method allows the use of any size of k-mer or k-tuple. However in a preferred embodiment the size of k-mer can be divided by 4. Therefore the k-mers may be of size 4, 8, 12, 16, 20, 24, 28, 32, 36, 40, 44, 48, 52, 56, 60, 64 or longer. More preferably the k-mers are of length between 16 and 64, more preferably between 16 and 32. Longer k-mers make the method more sensitive to sequencing errors and shorter k-mers increases the number of random hits thereby providing noise.

In one embodiment the k-mers are consecutive, and preferably the k-mers stored in the database are consecutive in order to cover the whole reference sequence.

Preferably, the k-mers from the source sequences are overlapping and incremental by at least one base or amino acid, such as at least two, for example at least 3, such as at least 4, for example at least 5, such as at least 6 or more. This corresponds to sliding a window of width k across the sequence. The window can slide by one, two or more bases/amino acids across the sequence. By making overlapping and incremental k-mers from the source sequence the method becomes less sensitive to sequencing errors or point mutations as the k-mer on either side of e.g. a single base mutation/error will be identified in the query. Hence the consecutiveness can be calculated with higher precision.

The use of disjoint k-mers, resulting from the concatenation of disjoint subsequencess in the source sequences, is also possible.

Preferably according to the method, k-mers from a given sequence are queried against the database to determine the presence of the k-mer in one or more reference sequences and the position of the k-mer in said one or more reference sequences. In order to optimise the database use, position is preferably only queried if the k-mer is present in the database.

In order to allow a quantitative evaluation of the querying, the method involves calculating a score for identified reference sequences, the score being correlated to the number of k-mers from one or more sequences found in a given reference sequence. This score may e.g. be divided by the length of the source sequence. A further score may be calculated for identified references, the further score being correlated to the consecutiveness of k-mers from one or more sequences found in a reference sequence. For example the score may be the percentage of k-mers from one source sequence that are found in the database and the longest sequence of k-mers found in one reference sequence in the database.

Similarly for each identified reference sequence a score may be calculated for identified references, the score being correlated to the number of k-mers in a reference sequence which are also present in the sub-set of k-mers from the source. One example may be the percentage of k-mers from one reference in a database that are found in the source sequences. In many practical applications, several hundreds of source sequences are queried and scored in order to obtain a satisfactory certainty. This score may also include a score based on the consecutiveness of the identified k-mers.

These scores are preferably calculated for each distinct source sequence such as wherein all k-mers from one source sequence are queried and one or more scores are calculated for said source sequence. Preferably, the method further involves querying all k-mers from a second source sequence, preferably from a third source sequence, etc. The scores for different source sequences may be combined e.g. by weighing them with the length of the source sequence.

In one embodiment of the present invention, once all k-mers that has been generated for a read have been processed, the number of contiguous positions matched in the references is used to isolate the largest clusters of matches, that is, the largest concentration of matching k-mers originating from the same read across all matching references. For each such cluster, a count is calculated by adding the number of k-mers in a cluster to the count of a given reference sequence. When the method is iterated over more than one read from a given sample, the count may be updated by adding the numbers of k-mers in a cluster to counts of reference sequences obtained from previous reads. That is, the counts may be updated by adding the number of k-mers for that reference and the list of k-mers already counted is up-dated. The next sequence, or read, may then be processed. A list of references to which is associated a count of k-mers found matching is obtained. For each pair <reference, count>, the count is divided by the number of unique k-mers in the query set, giving us a rough score for the amount of DNA in the queried sub-set matched by a given reference. If a queried sub-set is completely matching the sequence that score will be 1, it will be lower otherwise; for example, if the queried sub-set is a mixture in equal proportion of two references the score would be around 0.5 for both references. That count may also be divided by the size of the reference (or the number of unique k-mers in the reference sequence), giving a rough score for the fraction of the reference that is represented by the queried sub-set; that second score is helpful to sort the matching references, and avoid bias toward the largest references. The final score is a weighted sum of those two scores, for example wherein equal weights are used for each score.

In one embodiment of the invention a pre-selected number of source sequences are queried and a result is returned. However, in other embodiments the database querying can be stopped once a reference organism has been identified with predefined statistical probability. Similarly, the database querying can be stopped if a predefined fraction of k-mers are not found in the database or extended with more source sequence, or scores calculated with relaxed parameters. This can be in the case of junk sequences, sequences with many sequencing errors or a completely unknown sequence.

The output from the querying process may be a list of likely source references ranked according to one or more of said score or scores. Other examples of database outputs include one or more of the following pieces of information concerning one or more likely references: the taxonomic name of the likely reference, close relatives of said likely reference, the source of said reference, genetic linkage information, information about SNPs, position and annotation of genes in the sequences.

In a particular embodiment, the database outputs sequences of the most likely reference(s), preferably wherein the database outputs the full genomic sequence of most likely reference species. This allows the user to align the source sequences against the full genomic sequence of the most likely species using state of the art alignment algorithms to further investigate if there are mutations or inserts or a chromosome anomaly, abnormality or aberration. However, in one embodiment of the invention, the methods of the present invention do not involve the use of alignment algorithms on sequence data, for example such as alignment algorithms using scoring matrices, for example such as the Smith-Waterman algorithm [14], BLAST [1], BLAT [5], Bowtie, BWA, SHRiMP [16], or other alignment algorithms known by a skilled person.

In many cases, such as when microbiological sequences are queried, the database may comprise many closely related sequences, e.g. sequences from different isolates of the same species. In such a case, the results from references having very similar sequences can be grouped in the output. This may also allow the user to more easily identify a small piece of inserted DNA from another species or a different species being present in lower quantity.

In many cases, a sample contains a mixed population of species and sequencing of the whole genomes which will result in a mixture of genomic DNA from several species. In that case, the method may involve performing several iterations of the method, such as in a first iteration identifying the most abundant reference. In a second iteration, sequences from the most abundant species can be removed from the source sequences before querying the database or the method can involve ignoring further results from that species.

Alternatively, the output from one iteration of the method of the invention may comprise information and scores for all the references identified. The score in this case may include the percentage distribution among the different references.

This embodiment may also be used for identifying the reference of an insert, such as a viral insert, a transgene or an insert from another bacterial species.

In many embodiments, the user will initially know that sequences or short reads from one reference is present in a sample and the task is then to identify a likely reference of any other sequence(s) or short reads present in the sample. This can be in the case of diagnostics, where a sample contains both human DNA and DNA from a possible pathogen. Other examples include identification of harmful bacteria in food samples, where it is known that a sample contains DNA from the food source (e.g. salad, tomato, cucumber, meat from a particular species) and the task is to identify the presence and identity of any contaminating DNA. In such methods the method may involve initially removing source sequences that align to sequences from a pre-defined reference. Alternatively, the method may involve ignoring k-mers from one or more pre-defined references.

In one embodiment, the method involves sampling and querying raw reads as they are obtained from a nucleic acid sequencer.

When having a query set of DNA data to identify, such as short reads or raw reads from a sequencer for the purpose of diagnostics, we consider brute-force approach that consists in mapping or aligning all reads against comprehensive reference databases to have the two main disadvantages: first hundreds of megabytes or gigabytes of data much the either transferred from the sequencing facility to a computing centre, and secondly the computing resources necessary to perform the task are significant. Assuming that a reference collection contains 10,000 E. coli-sized bacteria and that it takes 30 seconds for an optimized aligner such as BWA and bowtie2 to process 250 Mbases of raw sequencing data (about 60× in average coverage if the genome is 4 Mbases in size), it would take 3 and a half day on a CPU, although this could be parallelized trivially on multiple CPUs. Refinements such the concatenation of the genomes could be made but at the cost of requiring ever increasing amounts of memory, post-processing computation to assign mapping positions to initial reference genomes, and inevitable multiple matches as close genomes are referenced, something that short read aligners are often uncomfortable with. The time complexity of locating the n occurences of a string of length p in a reference of size u using an FM-Index has an upper bound O(p+n log εu), meaning that although the complexity is growing slowly as the size of the reference is increasing, with a term in log ε, it is growing linearly with the number of highly similar genomes. Our approach embraces the perspective of enormous reference databases and do not try to keep it in all the RAM of one computer.

Database

In one aspect the invention relates to a database comprising k-mers of reference sequences, said database comprising:
a. A first collection of k-mers from reference sequences, and
b. A second collection of positions of each k-mer in the reference sequences.

The database architecture allows very rapid querying of k-mers from source sequences as illustrated in the appended examples, which demonstrate that results may be returned in a matter of seconds.

The database may further comprise information about the full length sequence associated with a given reference, and/or the source of said reference, and/or one or more taxonomic descriptors of said reference. Additional information that can be stored is information about genes annotated in DNA sequences.

When building the database, k-mers can be subjected to a hashing function assigning a unique key to each unique k-mer. Other possibilities include a search tree or a combination of hash function and search tree. The unique key may be associated with information about those references in which the k-mer is present.

In the second collection each unique k-mer in the second collection may also be used as a key and be associated through a hash table, a search tree, or combination thereof, to information about the k-mer's position in each reference, where it is present. This collection may comprise further information about the position in which the k-mer is present, such as an association to any annotation of a sequence such as coding sequence, regulatory sequences etc.

One or more further pieces of information about a reference sequence in which a given k-mer is present, such as an association to any annotation of a sequence, coding sequence, regulatory sequences, the taxonomic name of the likely reference, close relatives of said likely reference, the source of said reference, a group of further related references, where the reference was obtained from (soil, sea, gut, sewer, etc), when the reference sequence was obtained, taxonomic classification, close species, information regarding which database the reference sequence was downloaded from (e.g., NCBI, EBI/Sanger), or other pieces of information may be also be stored in a separate database, such as a SQL database, which may be additionally used to retrieve information regarding a reference sequence according to the present invention.

With the term “a group of further related sequences” is meant sequences from the samples taken in similar environments such as soil, sea, gut, sewer, etc.

Thus in one embodiment of the invention, the database comprising k-mers of reference sequences comprises:
a) A first collection of k-mers from reference sequences, and
b) A second collection of positions of each k-mer in the reference sequences.
c) A third collection or database with reference identifies and one or more pieces of information selected from the group consisting of a description line, the source of data, the taxonomic name of the likely reference, close relatives of said likely reference, the source of said reference, information of a group of further related references, where the reference was obtained from (soil, sea, gut, sewer, etc), when the reference sequence was obtained, taxonomic classification, close species, information regarding which database the reference sequence was downloaded from (e.g. NCBI, EBI/Sanger or other databases.)

In a preferred embodiment, the first collection of k-mers is a key-value store or NoSQL database, for example KyotoCabinet) associating to each k-mer (key in the database) a list of identifiers corresponding to the references having that k-mer as shown in FIG. 1. The second collection of positions of k-mers in the reference sequences may be also be stored in a key-value store or NoSQL database, for example KyotoCabinet (see FIG. 1). The association between references identifiers and information pieces, such as a description line and the source of data, is stored in a separate SQL database.

The length of the k-mers in the database preferably matches the length of the k-mers in the source sequence, although given the adequate lookup. However, k-mers in the database are preferably non-overlapping. Using overlapping k-mers will increase the data processing time.

According to the present invention, indexed k-mers of reference sequences in a database can be overlapping or non-overlapping. In a preferred embodiment, the k-mers of the indexed reference sequences are non-overlapping. It will be appreciated by a skilled person that similar scoring principles may be used for indexed databases of non-overlapping or overlapping k-mers in reference sequences.

The time complexity of locating the n occurences of a string of length p in a reference of size u indexed with k-mers has a complexity of O(p+n log u) or O(p+n) if a tree or hashing is used for the k indexing and lookup.

This does not exclude embodiments in which the k-mers are overlapping and incremental by at least one base or amino acid, such as at least two, for example at least 3, such as at least 4, for example at least 5, such as at least 6 or more.

In preferred embodiments, the complete genomic sequence of a given reference is fragmented in to k-mers and uploaded into the database. It is also conceivable to build a database based only on the transcriptome of a given reference or the proteome of a given reference.

If the purpose is merely to identify a likely reference of a source sequence, the database need not be complete. It may suffice to provide a random selection of genomic DNA from a particular reference. The selection may also be non-random, e.g. excluding stretches of repetitive DNA and so-called junk DNA.

For each type of biological sequence, protein, RNA, DNA, one database containing all available information can be built. In other embodiments specialised databases can be built for specialised purposes, such as where the purpose is merely to identify the presence or absence of a given reference sequence from the source sequences. For example the database may comprise sequence information from human beings, animals, mammals, birds, fish, fungi, insects, plants, bacteria, archaebacteria, vira, and/or plasmids. A network of databases can also be built with requests about reads be forwarded by one server to one or several others if it does not find matching references with sufficiently high scores.

In order to make optimal use of hardware resources without compromising speed, the database may be divided into sub-databases that are stored on several different servers.

In other embodiments the database is organised into sub-databases according to one or more taxonomic descriptors selected from phylum, class, order, family, genus, and species, or one or more environmental descriptors such as source, distribution, origin, and usual frequency in searches.

The databases may be built as described in FIG. 1 and be stored using database engines known as a key-value store (e.g. BSDDB, KyotoCabinet, LevelDB, MongoDB, and others). Thus in one embodiment of the present invention, the databases are stored using a key-value store selected from the group consisting of BSDDB, KyotoCabinet, LevelDB, MongoDB.

Applications of the Algorithm

The method and systems of the present invention can be used in numerous applications, where there is a need to identify the likely source of DNA found in a sample.

Diagnosis

In medical therapy, there is a need to rapidly identify the likely source of an infection. This can be done using methods according to the present invention. Thereby a suitable treatment can be selected which will treat the infection in the most efficacious manner with the least side effects.

Further diagnostic applications relate to identification of viral inserts in cancer cells. In this application, it may be advantageous to filter fully human sequences from the sequences obtained in the raw reads or to simply ignore all human hits identified in the database. This will allow identification of the relatively small viral insert into the human genome.

Biodefense

In biodefense applications, there is a need for a quick and reliable identification of the species of infectious or pathogenic agent encountered. The present invention offers possibilities for rapid identification of the source without prior knowledge of the source.

As the methods of the invention allow distinction of species without prior knowledge of the species of pathogen.

Further applications in biodefense include identification of transgenic pathogens, wherein e.g. a toxic transgene has been inserted. The database advantageously also contains sequence information from state-of-the art plasmids. This will allow easy identification of the flanking regions of the insert. If the transgene comes from an organism found in the database, it also becomes possible to identify the source of the transgene. In that case, the database may return the name of the pathogen, the name of the organism from which the transgene comes, the gene encoded by the transgene, and the plasmid used for inserting the transgene.

Food Safety and Quality

Current methods for identifying potentially harmful infections in food are slow (based on isolation and growth of infectious organisms) or require previous knowledge of the source of infection (PCR based methods). The current method requires neither, and allows the authorities and manufacturers to simply isolate genomic DNA, sequence the DNA and upload the raw reads to a system capable of operating the method of the invention.

When looking for bacteria, fungi, or vira in a sample of food, it may be advantageous to query a fraction of the database that only contains sequences from bacteria, fungi, or vira. In that way any genomic sequence from the food (vegetable, fruit, meat) will be identified as not—present in the database and thereby improve the performance of the method.

Other applications include quality control. One possible application is identification of the species of meat such as minced meat, patees, ready-made meals, convenience food. There are numerous examples of attempts at fraud, wherein expensive meat such as cattle or lamb, has been replaced or “diluted” with less expensive meat such as pork.

Other possible quality control applications include determining the variety of a plant, such as grapes, apples, potatoes, etc.

Still other possibilities include control of water quality.

Hygiene and Prophylaxis

The present invention offers possibilities for hygiene control by enabling rapid identification of the source of DNA in samples taken in connection with cleaning procedures. Further applications include the identification of the likely source of contamination thereby enabling application of the hygienic techniques that are most suitable for elimination of a particular infectious agent.

Items

The invention is now described as arbitrarily numbered items 1 to 56, which are to be regarded as embodiments of the invention. The invention is further defined with reference to the appended claims.

1. A method of identifying the likely source of biological sequences, the method comprising:
a) Sampling a subset of sequences or short reads from a source,
b) Fragmenting sequences from the subset into k-mers,
c) Querying k-mers from said subset against a database comprising k-mers of reference sequences,
d) Determining which reference contain(s) the k-mers, and
e) Returning a description of likely source references.

2. The method of item 1, wherein the biological sequences or short reads are amino acid sequences.

3. The method of item 1, wherein the biological sequences or short reads are DNA or RNA sequences

4. The method of any of the preceding items, wherein k-mer querying involves determining exact match between query and reference k-mers.

5. The method of any of the preceding items, wherein the querying further comprises determining the position of the k-mers in the reference sequence.

6. The method of any of the preceding items, wherein presence and position are used to determine consecutiveness of query k-mers in reference sequences.

7. The method of any of the preceding items, wherein querying involves querying all k-mers from at least one source sequence or short read, preferably from at least 50, such as from at least 100, for example from at least 150, such as from at least 200, for example from at least 250, such as from at least 300, for example from at least 400, such as from at least 500, for example from at least 750, such as from at least 1000, such as from at least 1500, for example from at least 2000, such as from at least 2500, for example from at least 5000 or more sequences.

8. The method of any of the preceding items, wherein the source sequences are nucleotide sequences of at least 50 bases, preferably at least 100 bases, for example at least 150 bases, such as at least 200 bases, for example at least 250 bases, such as at least 300 bases, for example at least 400, at least 500 or more bases.

9. The method of any of the preceding items, wherein the subset of sequences comprises at least 1% of the discrete sequences, such as at least 2%, for example at least 4%, such as at least 5%, for example at least 6%, such as at least 7.5%, such as at least 10%, for example at least 15% such as at least 25%, for example at least 30%, such as at least 35%, for example at least 40%, such as at least 50%.

10. The method of any of the preceding items, further comprising selecting one or more further subsets of sequences and subjecting those to steps a) through e) of item 1.

11. The method of any of the preceding items, wherein the subset is random or filtered.

12. The method of any of the preceding items, wherein the k-mers are of size 4, 8, 12, 16, 20, 24, 28, 32, 36, 40, 44, 48, 52, 56, 60, 64 or longer.

13. The method of any of the preceding items, wherein the k-mers are consecutive.

14. The method of any of the preceding items, wherein the k-mers are overlapping and incremental by at least one base or amino acid, such as at least two, for example at least 3, such as at least 4, for example at least 5, such as at least 6 or more.

15. The method of any of the preceding items, wherein k-mers are the concatenation of disjoint subsequences.

16. The method of any of the preceding items, wherein k-mers from a given sequence are queried against the database to determine the presence of the k-mer in one or more reference sequences and the position of the k-mer in said one or more reference sequences.

17. The method of item 16, wherein position is only queried if the k-mer is present.

18. The method of any of the preceding items, wherein a score is calculated for returned references.

19. The method of any of the preceding items, wherein a score is calculated for identified reference sequences, the score being correlated to the number of k-mers from one or more sequences found in a given reference sequence.

20. The method of any of the preceding items, wherein a score is calculated for identified references, the score being correlated to the consecutiveness or approximate consecutiveness through the mean of local concentration of k-mers from one or more sequences found in a reference sequence.

21. The method of any of the preceding items, wherein a score is calculated for identified references, the score being correlated to the number of k-mers in a reference sequence which are also present in the sub-set of k-mers from the source.

22. The method of any of the items 18 to 21, wherein likely source references are ranked according to said score or scores.

23. The method of any of the preceding items, wherein all k-mers from one source sequence or short read are queried and one or more scores are calculated for said source sequenc or short read.

24. The method of item 23, further comprising querying all k-mers from a second source sequence or short read, preferably from a third source sequence or short read, etc.

25. The method of any of the preceding items, wherein the database querying can be stopped once a reference organism has been identified with predefined statistical probability.

26. The method of any of the preceding items, wherein the database querying can be stopped if a predefined fraction of k-mers are not found in the database.

27. The method of any of the preceding items, wherein the database outputs one or more of the following pieces of information concerning one or more likely references:

the taxonomic name of the likely reference, close relatives of said likely reference, the source of said reference, a group of further related references.

28. The method of any of the preceding items, wherein the database outputs sequences of the most likely reference(s), preferably wherein the database outputs the full genomic sequence of most likely reference species.

29. The method of any of the preceding items, wherein results from references having very similar sequences or results from further related references are grouped in the output.

30. The method of any of the preceding items, wherein several iterations of the method are performed, such as in a first iteration identifying the most abundant reference, and removing sequences from said most abundant reference from the source sequences or short reads.

31. The method of item 30, further comprising in a second iteration identifying the second most abundant reference, removing sequences from said second most abundant reference, etc.

32. The method of item 30, further comprising in a second iteration identifying the likely reference of an insert.

33. The method of any of the preceding items, the method further comprising initially removing source sequences that align to sequences from a pre-defined reference.

34. The method of any of the preceding items, wherein the method comprises ignoring k-mers from one source sequence or short read, if a pre-defined number of k-mers from said source sequence or short read are not present in the database.

35. The method of any of the preceding items, wherein querying involves ignoring k-mers from one or more pre-defined references.

36. The method of any of the preceding items, wherein raw sequences are queried as they are obtained from a nucleic acid sequencer.

37. A database comprising k-mers of reference sequences, said database comprising:
a. A first collection of k-mers from reference sequences, and
b. A second collection of position of each k-mer in the reference sequences.

38. The database of item 37, wherein the database further comprises information about the full length sequence associated with a given reference, and/or the source of said reference, and/or one or more taxonomic descriptors of said reference.

39. The database of any of items 37-38, wherein k-mers in the database are subjected to a hashing function assigning a unique key to each unique k-mer.

40. The database of any of items 37-39, wherein each unique k-mer in the first collection is associated by a vector to information about those references in which the k-mer is present.

41. The database of any of items 37-40, wherein each unique k-mer in the second collection is associated by a vector to information about it's position in each reference, where it is present.

42. The database of any of items 37-41, wherein the k-mers are of length 4, 8, 12, 16, 20, 24, 28, 32, 36, 40, 44, 48, 52, 56, 60, 64 or longer.

43. The database of any of the items 37-42, wherein the k-mers are non-overlapping.

44. The database of any of the items 37-43, wherein the k-mers are overlapping and incremental by at least one base or amino acid, such as at least two, for example at least 3, such as at least 4, for example at least 5, such as at least 6 or more.

45. The database of any of the items 37-44, wherein the database comprises k-mers from the complete sequence of each reference.

46. The database of any of the items 37-46, wherein the database comprises sequence information from human beings, animals, mammals, birds, fish, fungi, insects, plants, bacteria, archaebacteria, vira, and/or plasmids.

47. The database of any of the items 37-46, wherein the database is divided into sub-databases that are stored on several different servers.

48. The database of any of the items 37-47, wherein the database is organised into sub-databases according to one or more taxonomic descriptors selected from phylum, class, order, family, genus, and species, or one or more environmental descriptors such as source, distribution, origin, and frequency in past queries.

49. A data processing system for identifying the likely source of a source sequences, the system comprising an input device, a central processing unit, a memory, and an output device, wherein said data processing system has stored therein data representing sequences of instructions which when executed cause the method of items 1-36 to be performed, the memory further comprising a database according to any of the items 37-49.

50. The system of item 49, wherein the database is stored in a server, and the input and output devices are a client, the client and server being connected via data communication connection.

51. The system of any of the items 49-50, wherein the client is selected form a personal computer, a stationary PC, a portable PC, a hand-held computing device such as a smart phone.

52. The system of any of the items 49-51, wherein the client comprises a sequence of instructions enabling the client to sample a sub-set of source sequences, fragment these into k-mers, and transmit these to the server.

53. The system of item 49-52, the client further comprising a sequence of instructions allowing it to perform assembly of source sequences into one or more larger sequences based on sequences transmitted to the client from the server.

54. The system of any of the items 49-53, being connected via a data connection to a sequencing apparatus.

55. A computer software product containing sequences of instructions which when executed cause the method of items 1 to 36 to be performed.

56. An integrated circuit product containing sequences of instructions which when executed cause the method of items 1 to 36 to be performed.

### EXAMPLES

Rapid Identification of Sequences with k-mers.

Here we present novel method, Tapir, that is capable of quickly pointing the likely origin of DNA or RNA and is able to work directly on the raw reads obtained from a DNA sequencer. Our system consists in a server, referencing known DNA, and a client with DNA data to be qualified. To demonstrate the use, we have referenced thousands of bacterial genomes, phages genomes, phages, and plasmids, as well as the human genome, the mouse genome, A. thaliana, and various sequences from fungi, archaebacteria. We also have implemented a client running in a web browser, and are able to process gigabases of data of data from a portable computing device. The method relies on indexing k-mers, and on transferring a limited amount of data to the server. It is able to perform its task within seconds from an Android smart phone, consuming a modest amount of bandwidth communicating with the server, and to the best of our knowledge provides a simplicity to use unlike any currently existing tool. It is in use at our core facility for routine instant quality check in sequencing runs, and is available at http://tapir.cbs.dtu.dk

Introduction

The sequencing of DNA has become increasingly affordable across the last decade [13], to the point that stating it once more has itself become an absolutely banal remark.

Today's high-end sequencers have the capacity to process the equivalent of several human genomes or several hundred bacteria, and the next generation of sequencers is already beginning to become available, requiring much lower initial investments and providing flexibility over sequencing volumes. The sequencing of complete bacterial isolates is an affair of a day, and very soon an affair of hours. Recent announcements on nanopore sequencing [12] presented a USB-powered device, able to directly sequence DNA, and for a capital investment at unprecedented low levels as the sequencing device will be disposable. Oxford Nanopore, the company behind the future product has announced a release in 2012 [8]. Extracting DNA is a relatively simple procedure, and it is foreseeable that DNA sequencing will soon be a routine and cheap procedure in molecular biology. Patients will be sequenced routinely, outbreaks of infectious agents traced by their DNA, quality of water and food also monitored with DNA sequencing.

On the analytics side, local alignment of sequences, with pioneering tools such as the Smith-Waterman algorithm [14], has been a cornerstone of bioinformatics. Once applied between a query and a collection of references it allowed the ranking of alignments, letting researchers infer the origin and function of newly sequenced DNA or RNA from its similarity to already existing sequences. Although the methodology has come under criticism for being inaccurate at times [2, 11], its popularity remains indisputable with a large number of functional annotations in public databases having the mention by sequence homology. However, aligning newly obtained DNA to existing references archived in database remains a relatively demanding computational task. BLAST [1] and later BLAT [5] improved the speed, yet with the number of sequences currently available searching a new sequence against the pool of known sequences may take a relatively long time in an era where web search engines return results almost instantly. New tools designed for short-read sequencing have been since be developed, such as Bowtie [6] and BWA [7] to only name two, but those tools are designed to align all sequencing reads against a given reference. In order to achieve speed such tools load an index of the reference into memory, and with this limiting the amount of reference DNA that can be handled.

We see a gap between the computationally demanding task of finding the absolute best alignment between a query sequence and a collection of references, and identifying quickly from a set of query sequences the references they match most to. To our knowledge there is no simple tool that takes a set of short DNA or RNA sequences, such as the reads coming out of a DNA sequencer, and returns list a references, either full genomes or individual genes, the set is representative of. To do so, we propose to use k-mers in a distinct way from alignment seeds in both BLAT and SSAHA [9, 10] and k-mer counting in MUSCLE [3] in order to identifying rather accurately the source of DNA sequences in a matter of seconds or less.

Material and Methods

Publicly available genomes, contigs, plasmids, and individual genes available from the EBI and the NCBI were downloaded to be our reference DNA. Each reference sequence was split into on-overlapping k-mers and for all k-mers across all references a key-value store, or NoSQL database (we used KyotoCabinet [4]), was created, associating to each k-mer (key in the database) a list of identifiers corresponding to the references having that k-mer (FIG. 1). We called this the presence database. Similarly, the positions in the reference at which the k-mer is found were stored in what we call the position database (FIG. 1). The association between references identifiers and information, such as a description line and the source of data, were stored in a separate SQL database.

In order to score a set of short query sequences, or reads, we iterate through a random sample of them (FIG. 2). For each sequence, we iterate over the consecutive k-mers obtained by sliding a window of width k across the sequence. For each k-mer, if it has not been counted before and it is found in the presence database we then query the position(s) for the reference(s). Once all k-mers for a read have been processed, we look at the number of contiguous positions matched in the references and only consider the largest clusters of matches, that is the largest concentration of matching k-mers originating from the same read across all matching references. For each such cluster, we add the number of k-mers to a possibly previously added number for that reference and we update the list of k-mers already counted. The next sequence, or read, is then processed. We obtain a list of references to which is associated a count of k-mers found matching. For each pair <reference, count>, the count is divided by the number of unique k-mers in the query set, giving us a rough score for the amount of DNA in the query matched by a given reference. If a query set is completely matching the sequence that score will be 1, it will be lower otherwise; for example, if the query set is a mixture in equal proportion of two references the score would be around 0.5 for both references. That count is also divided by the size of the reference (number of unique k-mers in the reference sequence), giving a rough score for the fraction of the reference that is represented by the query; that second score is helpful to sort the matching references, and avoid bias toward the largest references. The final score is a weighted sum of those two scores, default being equal weights. If the query set is large, for example if we are considering all reads coming out of a DNA sequencing run, we only use a random sample of that set.

To facilitate the use of the service implemented an HTML5/Javascript client running as a page in a web browser. At the time of writing Firefox 15.0 was the only browser implementing all needed features, and we tested to work on Linux, Mac OS X, Microsoft Windows, and Android 4.0.

To benchmark our system, originally designed to identify bacteria in sequencing data, we iteratively took what was all sequences from bacteria available from the EBI at the beginning of 2012, that is 747 bacterial genomes. For each genome, we generated random possibly overlapping sub-sequences from the genome sequence in order to simulate reads obtained from a DNA sequencer; sub-sequences of length 50, 100, 150, 200, and 250 bases were used. We also introduced uniform random substitutions of bases with rates of 0% (no error), 1%, 5%, and 10% in order to both simulate a class of sequencing errors and the presence of punctual mutations in real samples. For each genome, length, and substitution rates, a random sample of 100 sub-sequences, or reads, was taken and that sampling repeated ten times.

Results

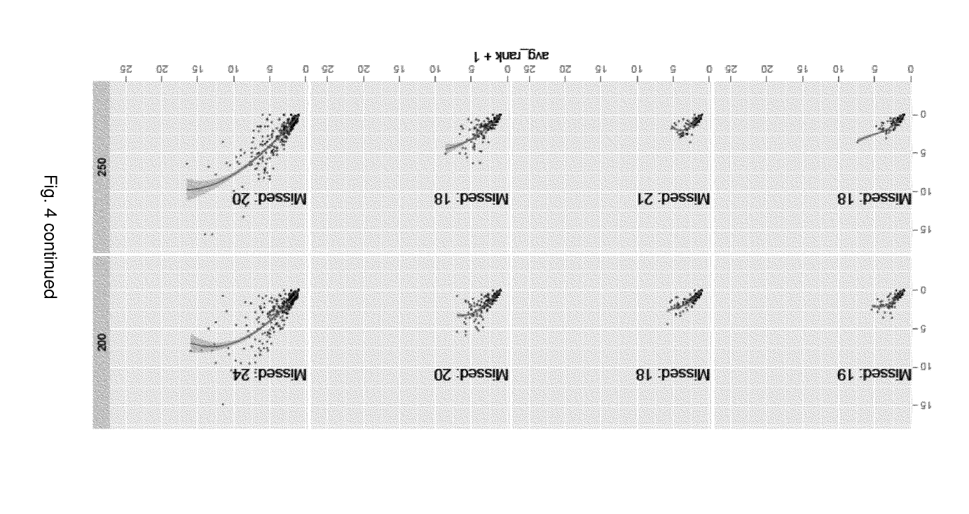

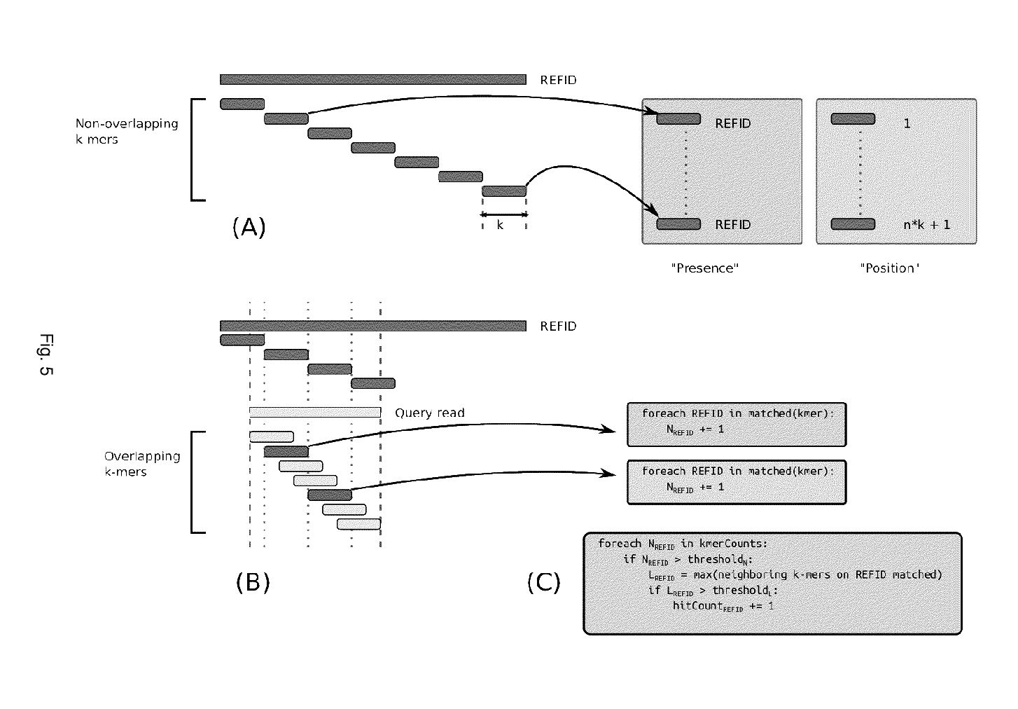

For each bacterial genome, we took 100 random simulated reads and scored them against a database comprising those bacterial genomes, among other references, using our method, recording the rank of the query genomes in a list of the 25 best scores. Average ranks and the standard deviation for the ranks are shown FIG. 4.

The closer the average rank is to 1 the better the scoring, and the smaller the standard deviation of the ranks the less sensible to sampling effects. The number of missing ranks, written in each individual panel corresponds to the number of genomes which were not in the 25 highest scores.

Performances are less than optimal with reads of 50 bases in length, but there is a dramatic improvement already with read of 100 bases with the query genome between 97% and 99% of the times in the top 5 with low substitution rates and in the top 15 with higher substitution rates. Increasing the read length up to 250 bases helped compensating for the negative effect of the higher substitution rates on the average rank.

The range of lengths and substitution rates we used are comparable to the ones obtained from next-generation sequencing platforms such as Illumina (100 bases with an error rate of about 0.1-1%, Life Technologies' SOLiD 5500 (75 nt reads with an error rate of 0.01%), Ion Torrent PGM (200-300 bases with an error rate of 1%), or Pacific Bioscience (3,000 bases with an error rate of 15%). Our method performs well within those ranges and we anticipate increasing performances further by adding support for paired-end sequencing, a technique used to provide a substitute for longer reads, is implemented. Our method appears relatively insensitive to sequencing errors such as base substitutions and the expected low rank for our test queries were minimally affected as substitution rates increased.

Thanks to the use of a NoSQL database, we anticipate to scale up as genomic data get increasingly abundant, and continue being able to index and query increasingly large collections of references on relatively affordable computer systems.

To facilitate the use of our method, we developed a browser based client. We tested with raw FASTQ files up to 2 Gb in size, and monitored it to only use a little over 200 Mb in RAM and return results in under 20 seconds.

Conclusion

The concept underlying TAPIR is rather simple. The increase in size of DNA databases has been announced and observed for at least over a decade, but recent developments in DNA sequencing technology have made fast and affordable generation of data a reality. We are arguing that matching experimentally-obtained DNA sequences against all known DNA is one of the most important challenges in bioinformatics. We show here that this can be done with a speed and ease that matches what the internet web search giants have made the general public used to. When considering tasks such as real time surveillance, such infections in patients, biodefense, or food safety, with desktop DNA sequencers, our method provides an immediate early step during which the search space can be narrowed down and more advanced analysis methods can be performed afterwards.

### Example 2

In the present example, tens of thousands of genomes and genomic regions from bacteria, viruses, phages, plasmids, as well as human, mouse, plants, fungi, and archaebacteria were referenced. We also implemented a client running in a web browser, and demonstrated the use of the client to process and identify gigabytes of raw sequencing data from a commodity portable computing device within seconds, while consuming a modest amount of bandwidth communicating with the server. Thus, in the present example it is shown that the identification of DNA from raw reads can be as easy as querying a search engine.

Matching Sets of Query DNA Sequences Against a Comprehensive Collection of References

A subjective way of looking at the alignments programs is to split them into two main categories: the ones trying hard to map one query sequence a collection of known reference (e.g., BLAST), and the ones trying to map a large number of short sequences against one specified reference as quickly as possible (e.g., bowtie or BWA). We propose an intermediate approach where a good reference can be identified for the large number of short sequences; we match several sequences against a collection of reference sequences and vote which references are represented most in the query set.

The approach presented in the present example does not involve any selection steps during the indexing of k-mers, and this feature greatly simplifies the complexity when building from a collection of sequences. This comes at the cost of space, with potentially less informative k-mers being indexed, but this is offset by the following benefits: the process is linear in the total size for the collection of references and can be parallelized trivially. This makes the indexing of all known DNA eventually plausible (similar to the indexing of web search engines of all documents on the internet.)

In this example, our algorithm does more than just count the k-mers, yet it does not perform a full mapping or alignment either. The algorithm takes into account the matching k-mers within the context of each read, as well as clusters of matching k-mers close to one another.

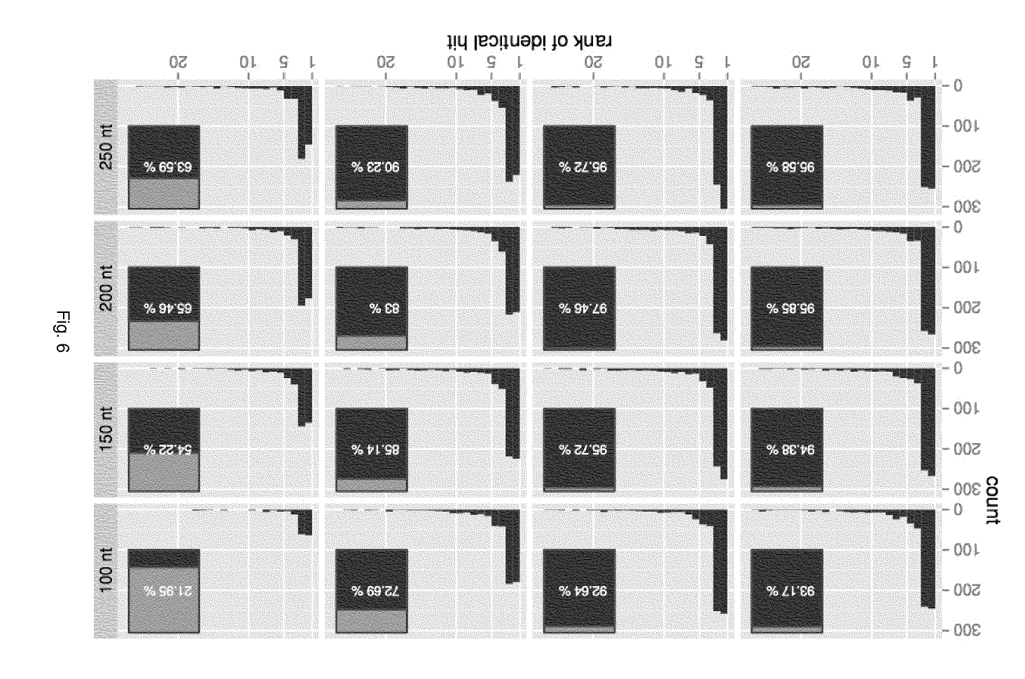

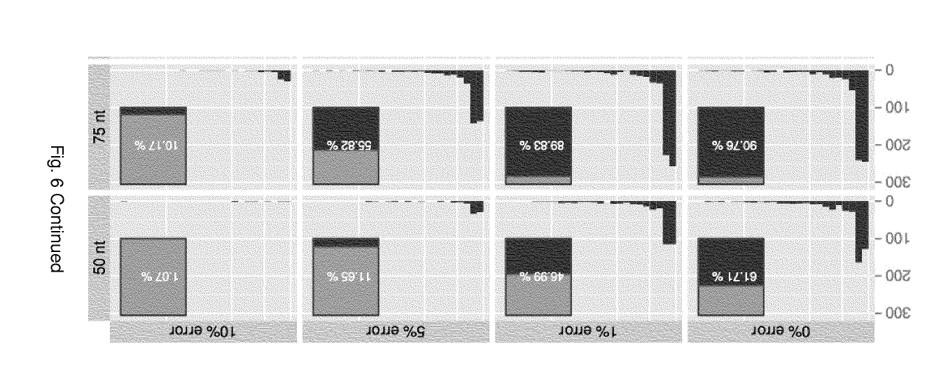

In the present example, we have used non-overlapping k-mers for the indexing while we used overlapping k-mers in the queries, as shown FIG. 5, but we consider this an implementation detail and could easily use overlapping k-mers for the indexing and non-overlapping k-mers in the queries while keeping the same guiding principles for giving scores to matching references.

The time complexity of locating the n occurences of a string of length p in a reference of size u indexed with k-mers using has a complexity of O(p+n log u) or O(p+n) if a tree or hashing is used for the k indexing and lookup.

When having a query set of DNA data to identify, such as raw reads from a sequencer for the purpose of diagnostics, we consider brute-force approach that consists in mapping all reads against comprehensive reference databases to have the two main disadvantages: hundreds of megabytes or gigabytes of data much the either transferred from the sequencing facility to a computing center, and the computing resources necessary to perform the task are significant. Assuming that a reference collection contains 10,000 E. coli-sized bacteria and that it takes 30 seconds for an optimized aligner such as BWA and bowtie2 to process 250 Mbases of raw sequencing data (about 60× in average coverage is the genome is 4 Mbases in size), it would take 3 and a half day on a CPU, although this could be parallelized trivially on multiple CPUs.

In addition to time complexity, the data transfer would be 250 Mbases of DNA, with the sequencing data moved to a data centre that holds the references. Our approach based on k-mers reduces detailed investigation such as mapping reads, or SNP calling, or even template-based de-novo assembly, to a small set of references. When evaluating performances we arbitrarily chose to initially only consider a search a success if the right answer is within a set of 5 proposed matches. The task of mapping all reads against those references in order to identify precisely which one is the best matching one can be performed in 12 minutes on the same CPU, or in much less if a powerful multicore architecture was acquired in prevision of the 3 and a half days per sample mentioned above. Transferring all genomes would represent about 20 Mbases of DNA, which could be performed easily over a 3G mobile internet connection. Our approach makes a mobile sequencing facility such as the Ion bus [15] able to perform critical diagnostics or scientific tasks in remote locations on the field. Should there be unmapped reads, because of the presence of a smaller regions such as a plasmid, virulence genes, a virus, or a mixture of bacteria, those reads can be processed similarly and the full content be identified over few iterations.

Building a Benchmark

To benchmark our system, originally designed to identify bacteria in sequencing data, we iteratively took what was all sequences from bacteria available from the EBI database circa the beginning of 2012, that is 747 bacterial genomes while the full database of references contained in addition to those: bacterial references from the NCBI, phages and viruses, plasmids, and the human genome (see Table 1 below). Table 1 shows a snapshot of genomic references (source and number of references) at the beginning of 2012. The references are a mixture of full genomes or plasmids, and of genomic fragments such as contigs or genes.

TABLE 1
Genomic references

| Database | Number of references | Size (DNA bases) |
|---|---|---|
| HIV | 4053 | 36471153 |
| Phage genomes (Sanger) | 1078 | 59538128 |
| Viral genomes (Sanger) | 3464 | 64859892 |
| Bacterial genomes | 747 | 2418028337 |
| (Sanger) | | |
| Bacterial genes (NCBI) | 5218077 | 4963568551 |
| Bacterial genomes (NCBI) | 4693 | 2418028337 |
| Viral genomes (NCBI) | 1750 | 60637755 |
| Fungi | 202270 | 298736207 |
| Human Microbiome | 1653700 | 1490442185 |
| sequences | | |
| Plasmids | 159705 | 132800479 |
| Virii | 78630 | 65110952 |
| Homo sapiens (Hg19) | 3134 | 2844000504 |
| Mus musculus | 305 | 2745142291 |
| Plant (RefSeq) | 558267 | 8622349159 |
| Invertebrates (Genbank) | 1123813 | 18429666992 |
| Protozoa (Genbank) | 47275 | 1997449553 |
| Fungi (Genbank) | 200 | 242402709 |

For each genome, we generated random possibly overlapping sub-sequences from the genome sequence in order to simulate reads obtained from a DNA sequencer; sub-sequences of length 50, 100, 150, 200, and 250 bases were used. We also introduced uniform random substitutions of bases with rates of 0% (no error), 1%, 5%, and 10% in order to both simulate a class of sequencing errors and the presence of punctual mutations in real samples. For each genome, length, and substitution rates, a random sample of 100 sub-sequences, or reads, was performed and that sampling repeated 5 times.

Our purpose is to assess whether we can find what known DNA is in a sample, or a genome close enough when counting uncertainty such as sequencing errors or mutations.

Prediction Performances

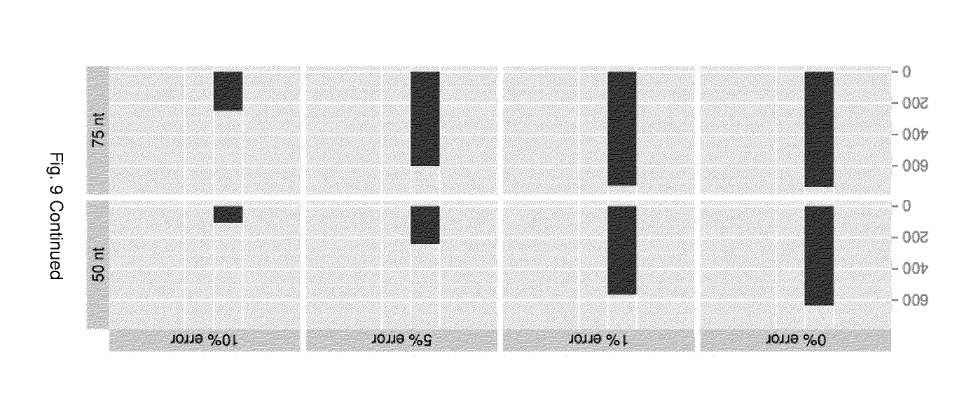

For each bacterial genome, we took 100 random simulated reads and scored them against a database comprising those bacterial genomes, among a larger collection of sequences and genomes from other bacteria, phages, plant, fungi, viruses, and mammalians using our method, recording the rank of the query genomes in a list of the 25 best matching references. In order to assess the variability of the results for each test bacterial genome, this was repeated 5 times for each genome and the average ranks and the standard deviation for the ranks are presented FIG. 9.

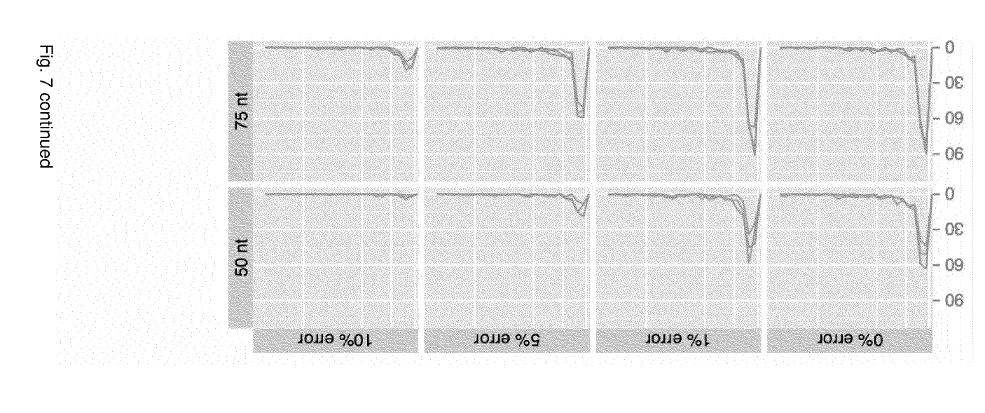

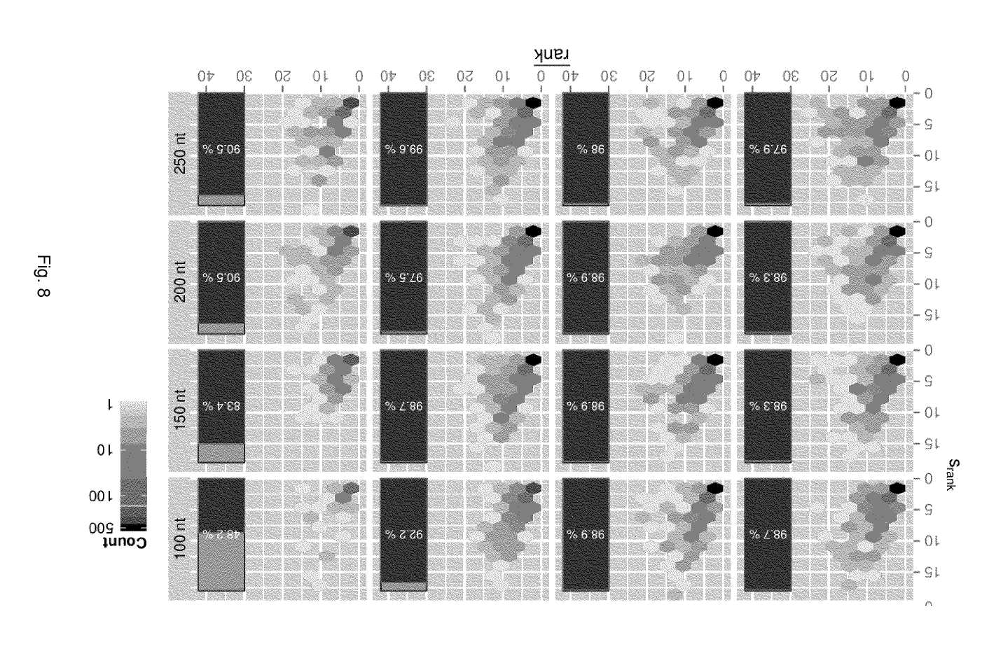

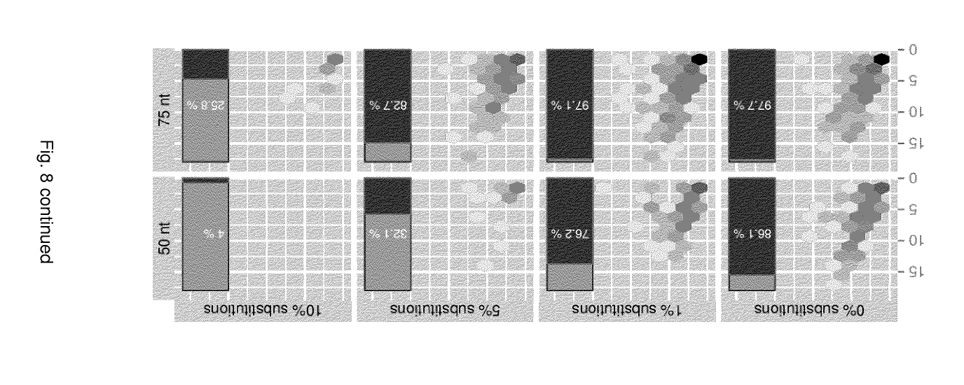

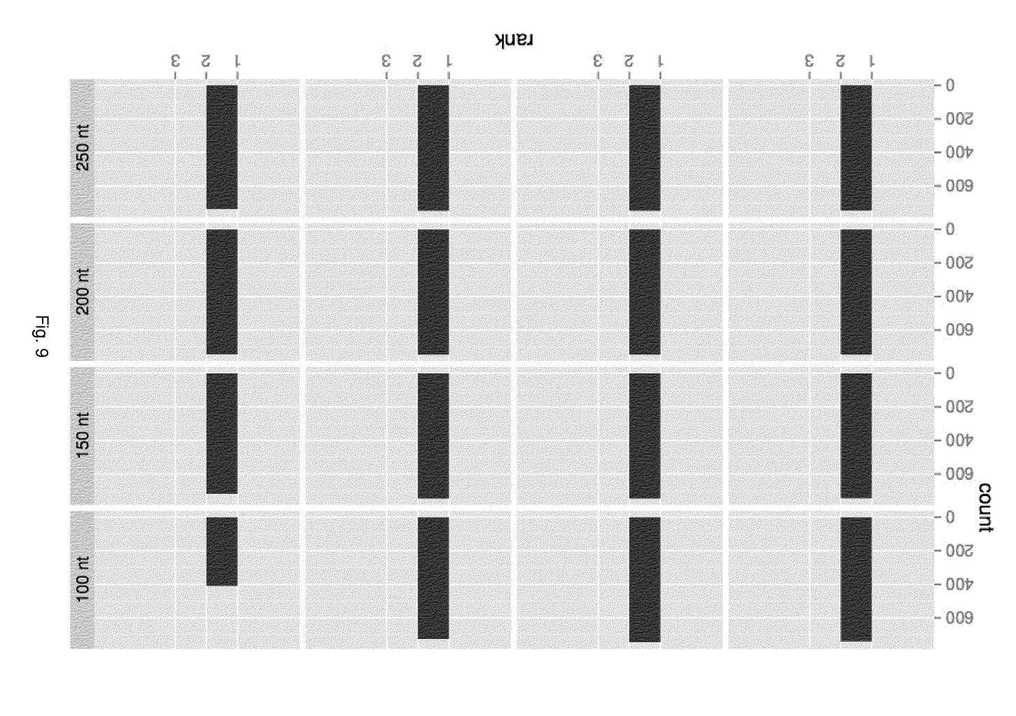

Performances were relatively low with reads of 50 nucleotides in length, but we observed dramatic improvement when increasing the read length, with reads of length 100 in sequenced bases already close to the maximum performances. The best results are showing that the correct genome is in the list of results over 97% of the times for lower error rates in the top 5 with low substitution rates and in the top 15 with higher substitution rates. Increasing the read length to up 250 bases helped compensating for the negative effect of increasing error rates. Increasing the number of reads in the random sample sent for identification did not have much effect, see FIG. 7: 100 reads is a small amount of data, yet it appears sufficient to identify DNA in a large number of cases.

As detailed earlier our method aims at returning the right reference within a set of proposed matches and by doing so simplify the search space that a brute-force approach would require exploring with computationally demanding procedures. Restricting ourselves to finding the query sequence within the top five results is probably stricter than necessary, as running the analysis all 25 would still be significant compared to an exhaustive search, but points out that the method is already able to return the right answer within very small sets of candidate answers.

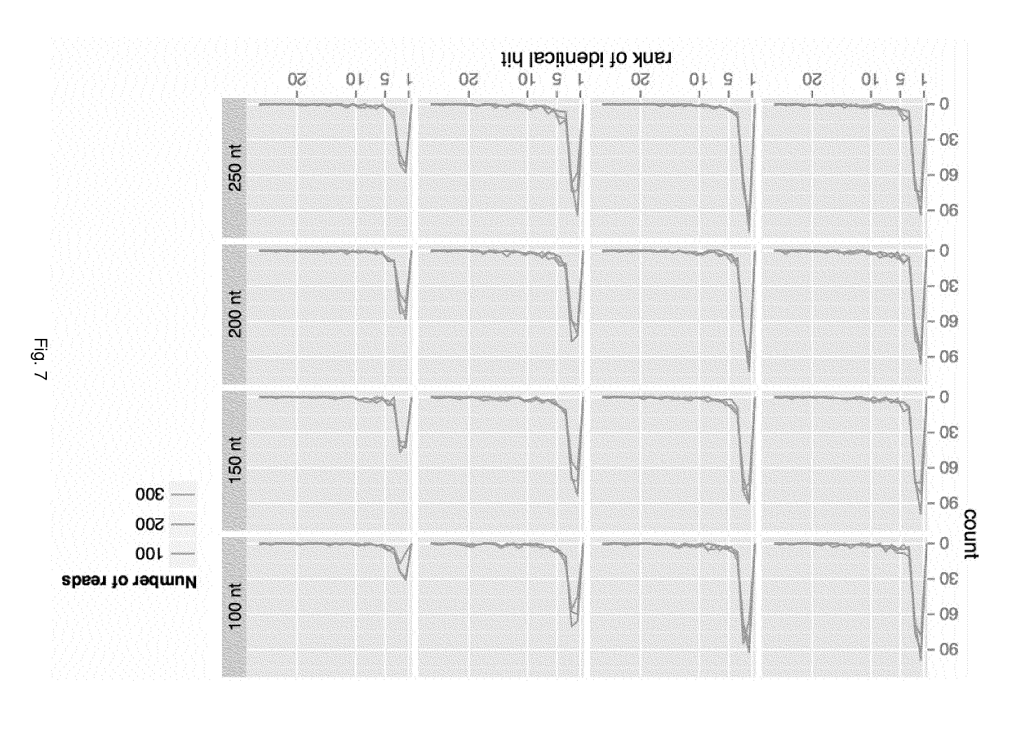

In the context of iterative search and identification one can consider that pointing out the right bacterial specie, even if not the correct precise strain or genomic reference, is already a relatively successful answer. FIG. 6 shows that our identification procedure is performing very well with reads that are above 50 nucleotides.

The range of lengths and substitution rates we used are comparable to the ones obtained from next-generation sequencing platforms such as Illumina (maximum of 150 bases with an error rate of about 0.1-1%, Life Technologies' SOLiD 5500 (maximum of 75 nt reads with an error rate of 0.01%), Ion Torrent PGM (maximum of 200-300 bases with an error rate of 1%), or Pacific Bioscience (3,000 bases with an error rate of 15%). Our method performs well within those ranges and we anticipate increasing performances further by adding support for paired-end sequencing (a technique used to provide a substitute for longer reads). Our method appears relatively insensitive to sequencing errors such as base substitutions and the expected low rank for our test queries were minimally affected as substitution rates increased.

We have also tried the approach on sequencing data from Ion Torrent PGM from samples ranging from viral and bacterial isolates to metagenomics mixtures. Very similar genomes in the collection of references indexed, such as several strains of the same species, can contribute to a degradation of the performances by increasing the probabilities to have closely related genomes with lower ranks than the correct reference genomes. This is confirmed by the increased performances when considering the species rather than the exact reference, and this is a moderate inconvenience that can be disambiguated during a second iteration. Finally because we have considered k-mers within the context of reads rather than isolated entities we obtained very promising results with sequencing from samples from diverse mammalians, and anticipate to reliably identify them in the near future.

Computing Performances

Server:

Memory usage on the server can be kept minimal by using a disk-based key value store, and tuning performances can be achieved by caching those into the memory available on the computer running it. Thanks to the use of a NoSQL database, we also anticipate to be able scale up as genomic data get increasingly abundant, and continue being able to index and query increasingly large collections of references on relatively affordable computer systems.

With the current implementation both the indexing system and the server are implemented in Python, the indexing of 44 Gbases of reference DNA being performed in few hours using 8 cores (Intel Xeon, 2.93 GHz), and the processing of one incoming sample taking few seconds. A significant speedup could be achieved with optimization efforts such as bottlenecks moved to C, but it also possible to increase global performances in the handling of more requests by dedicating more cores, should the need become apparent.

Client:

To facilitate the use of our method, we developed a browser based client using Javascript and HTML5 features that can be accessed at http://tapir.cbs.dtu.dk. The client is currently working on the latest Firefox release (version 15 or greater).

With Firefox running on a relatively modest laptop with an Intel Core i5 CPU clocked at 2.53 GHz, the raw reads in a FASTQ file up to 2 Gb in size could be processed in under 30 seconds, the smaller the file the fastest, using a little under 300 Mb in RAM, and few seconds communicating with the server.

We further implemented a console-based command line tool to perform our algorithm and subsequent alignment. The implementation is made available on a popular software repository: https://bitbucket.org/Igautier/dnasnout-client. The implementation uses our algorithm to the fetch reference genomes, and do their indexing and mapping of all reads with bowtie2. The complete iteration takes under a minute when considering the 10 top reads and one iteration is sufficient in 98% of the cases. With the rapid development of browsers we anticipate soon to be able to carry out a workflow similar to what an epidemiology laboratory would do with desktop sequencing runs using only a web browser.

Discussion

We are arguing that matching experimentally-obtained DNA sequences against all known DNA is one of the most important challenges in bioinformatics. We have shown here that this can be done with a speed and ease that matches what the internet web search giants have made the general public used to. When considering tasks such as real time surveillance, such infections in patients, biodefense, or food safety, today's desktop DNA sequencers such as the Ion Torrent PGM or Illumina MiSeq are already up to the task and our method provides an immediate early step during which the search space can be narrowed down and more advanced analysis methods can be performed locally afterwards, without the need to transfer large amounts of raw data between a laboratory performing the DNA sequencing and a computing facility.

Methods

Sources of Genomic References:

Publicly available genomes, contigs, plasmids, and individual genes available from the EBI and the NCBI were downloaded to be our reference DNA. The exact composition of the references will be expanding with time, but we listed the snapshot used for the present example in Table 1.

Indexing of References:

Each reference sequence was split into non-overlapping k-mers and for all k-mers across all references, a key-value store, or NoSQL database (we used KyotoCabinet [4]), was created, associating to each k-mer (key in the database) a list of identifiers corresponding to the references having that k-mer. We called this the presence database. Similarly, the positions in the reference at which the k-mer is found were stored in what we call the position database. k was chosen to be equal to 16, as it gave us satisfactory results, and as a multiple of 4 was well-suited for bit-packing. The association between references identifiers and information, such as a description line and the source of data, were stored in a separate SQL database.

Scoring:

In order to score a set of short query sequences, or reads, we iterated through a random sample of them. The larger the sample size the more reliably accurate it will become. For each sequence, we iterated over the consecutive k-mers obtained by sliding a window of width k across the sequence. For each k-mer, if it was not counted before and it is found in the presence database we then queried the position(s) for the reference(s). Once all k-mers for a read had been processed, we looked at the number of contiguous positions matched in the references and only considered the largest clusters of matches, that is the largest concentration of matching k-mers originating from the same read across all matching references. For each such cluster, we added the number of k-mers to a possibly previously added number for that reference and we updated the list of k-mers already counted. The next sequence, or read, was then processed. When all reads had been processed we obtain a list of references to which is associated a count of k-mers found matching. For each pair <reference,count>, the count was divided by the number of unique k-mers in the query set, giving us a rough score for the amount of DNA in the query matched by a given reference. With the illustrated scoring principle, if a query set is completely matching the sequence that score will be 1, otherwise it will be lower; for example, if the query set is a mixture in equal proportion of two references the score would be around 0.5 for both references. That count was also divided by the size of the reference, giving a rough score for the fraction of the reference that is represented by the query; that second score is helpful to sort the matching references, and avoid bias toward the largest references. The final score was calculated as a weighted sum of those two scores, wherein equal weights were used. If the query set is large, for example if we are considering all reads coming out of a DNA sequencing run, we only use a random sample of that set.

Implementation of a Client:

To facilitate the use of the service, we implemented an HTML5/Javascript client running as a page in a web browser. For the present study, Firefox version 15 was used, and we tested it to work on Linux, Mac OS X, Microsoft Windows (various laptops and desktops), as well as on Android 4.0 (tablet ASUS TF101—we anticipate that it would also work from an high-end smartphone). However, the skilled person will appreciate that other suitable browsers may be useful as well. The client is also implemented as a Python library and command-line tool for easy evaluation and integration in existing workflows and pipeline.

Other Technical Specifications:

At the exception of bindings to libraries such as KyotoCabinet, all implementation was made using Python version 2.7.3 on the server side. The web application is using the micro-framework Flask and is served by lighttp. The client-side library and command-line tool was developed for Python version 3.3.

The skilled person will appreciate that the implementation of the algorithm or parts of the algorithm can be done in other suitable and generally known programming languages such as for example the C programming language which may improve the performance of the method by decreasing the time used for querying.

### REFERENCES

[1] Stephen F. Altschul, Warren Gish, Webb Miller, Eugene W. Myers, and David J. Lipman. Basic local alignment search tool. Journal of Molecular Biology, 215(3):403-410, October 1990.

[2] Damien Devos and Alfonso Valencia. Practical limits of function prediction. Proteins: Structure, Function, and Genetics, 41(1):98-107, October 2000.

[3] R. C. Edgar. MUSCLE: multiple sequence alignment with high accuracy and high throughput. Nucleic Acids Research, 32(5):1792-1797, March 2004.

[4] Mikio Hirabayashi. Kyoto cabinet: a straightforward implementation of DBM. http://fallabs.com/kyotocabinet/

[5]W. J. Kent. BLAT—The BLAST-Like alignment tool. Genome Research, 12(4):656-664, March 2002.

[6] Ben Langmead, Cole Trapnell, Mihai Pop, and Steven L Salzberg. Ultrafast and memory-efficient alignment of short DNA sequences to the human genome. Genome Biology, 10(3):R25, 2009.

[7] H. Li and R. Durbin. Fast and accurate short read alignment with burrows-wheeler transform. Bioinformatics, 25(14):1754-1760, May 2009.

[8] Christopher E Mason and Olivier Elemento. Faster sequencers, larger datasets, new challenges. Genome Biology, 13(3):314, 2012.

[9] Z. Ning. SSAHA: a fast search method for large DNA databases. Genome Research, 11(10):1725-1729, October 2001.

[10] Zemin Ning, W. Spooner, A. Spargo, S. Leonard, M. Rae, and A. Cox. The SSAHA trace server. pages 519-520. IEEE.

[11] Burkhard Rost. Enzyme function less conserved than anticipated. Journal of Molecular Biology, 318(2):595-608, April 2002.

[12] Nicole Rusk. Cheap third-generation sequencing. Nature Methods, 6(4):244-244, April 2009.[13] Jay Shendure and Hanlee Ji. Next-generation DNA sequencing. Nature Biotechnology, 26(10):1135-1145, October 2008.

[14] T. F. Smith and M. S. Waterman. Identification of common molecular subsequences. Journal of Molecular Biology, 147(1):195-197, March 1981.

[16]. Rumble S M, Lacroute P, Dalca A V, Fiume M, Sidow A, et al. (2009) SHRiMP:

accurate mapping of short color-space reads. PLoS Computational Biology 5: e1000386.

[17]. Li H, Homer N (2010) A survey of sequence alignment algorithms for next-generation sequencing. Briefings in Bioinformatics 11: 473-483.

[18]. Babraham bioinformatics—FastQ screen. http://www.bioinformatics.babraham.ac.uk/projects/fastq screen/. URL http://www.bioinformatics.babraham.ac.uk/projects/fastq_screen/.

1. A method of identifying the likely source of biological sequences such as short reads, the method comprising:
a) Sampling a subset of sequences or short reads from a source,
b) Fragmenting sequences from the subset into k-mers,
c) Querying one or more k-mers from said subset against a first collection comprising k-mers of reference sequences,
d) Querying one or more k-mers from said subset against a second collection comprising positions of k-mers in reference sequences
e) Determining which reference contain(s) the one or more k-mers, and
f) Returning a description of likely source references,
wherein the first collection comprising k-mers of reference sequences is separate from the second collection comprising the positions of k-mers in reference sequences.

2. The method of claim 1, wherein said method does not involve the use of alignment algorithms on sequence data, such as alignment algorithms using scoring matrices.

3. The method of claim 1, wherein the querying further comprises determining the position of the k-mers in the reference sequence.

4. The method of claim 1, wherein presence and position are used to determine consecutiveness of query k-mers in reference sequences.

5.-6. (canceled)

7. The method of claim 1, wherein k-mer querying involves determining exact match between query and reference k-mers.

8. The method of claim 1, wherein querying involves querying all k-mers from at least one source sequence or short read, preferably from at least 50, such as from at least 100, for example from at least 150, such as from at least 200, for example from at least 250, such as from at least 300, for example from at least 400, such as from at least 500, for example from at least 750, such as from at least 1000, such as from at least 1500, for example from at least 2000, such as from at least 2500, for example from at least 5000 or more sequences.

9. The method of claim 1, wherein the source sequences are nucleotide sequences of at least 50 bases, preferably at least 100 bases, for example at least 150 bases, such as at least 200 bases, for example at least 250 bases, such as at least 300 bases, for example at least 400, at least 500 or more bases.

10. The method of claim 1, wherein the subset of sequences comprises at least 1% of the sequences, such as at least 2%, for example at least 4%, such as at least 5%, for example at least 6%, such as at least 7.5%, such as at least 10%, for example at least 15% such as at least 25%, for example at least 30%, such as at least 35%, for example at least 40%, such as at least 50%.

11.-12. (canceled)

13. The method of claim 1, wherein the k-mers are of size 4, 8, 12, 16, 20, 24, 28, 32, 36, 40, 44, 48, 52, 56, 60, 64 or longer.

14. The method of claim 1 any of the preceding claims, wherein the k-mers are consecutive.

15. The method of claim 1 any of the preceding claims, wherein the k-mers are overlapping and incremental by at least one base or amino acid, such as at least two, for example at least 3, such as at least 4, for example at least 5, such as at least 6 or more.

16. (canceled)

17. The method of claim 1, wherein k-mers from a given sequence are queried against the database to determine the presence of the k-mer in one or more reference sequences and the position of the k-mer in said one or more reference sequences.

18. The method of claim 1, wherein position is only queried if the k-mer is present.

19. The method of claim 1, wherein a score is calculated for returned references.

20. The method of claim 1, wherein a score is calculated for identified reference sequences, the score being correlated to the number of k-mers from one or more sequences found in a given reference sequence.

21. The method of claim 1, wherein a score is calculated for identified references, the score being correlated to the consecutiveness or approximate consecutiveness through the mean of local concentration of k-mers from one or more sequences found in a reference sequence.

22. (canceled)

23. The method of claim 1, wherein likely source references are ranked according to said score or scores.

24.-34. (canceled)

35. The method of claim 1, wherein several iterations of the method are performed, such as in a first iteration identifying the most abundant reference, and removing sequences from said most abundant reference from the source sequences or short reads.

36.-55. (canceled)

56. A data processing system for identifying the likely source of a source sequences, the system comprising:
an input device;
a central processing unit;
a memory; and
an output device, wherein said data processing system has stored therein data representing sequences of instructions which when executed by the central processing unit cause the method of claims 1-35 to be performed, the memory further comprising a database comprising k-mers of reference sequences, said database comprising:
a) A first collection of k-mers from reference sequences, and
b) A second collection of position of each k-mer in the reference sequences.

57.-61. (canceled)

62. A computer software product containing sequences of instructions which when executed cause the method of claims 1 to 35 to be performed.

63. (canceled)
